(19) United States
(12) Patent Application Publication
(10) Pub. No.: US 2026/0349530 A1
(43) Pub. Date: Nov. 5, 2026

(54) SYSTEM AND METHOD OF A MIXED REALITY WORKSPACE ECOSYSTEM OF HARDWARE DEVICES FOR INTERACTION WITH A MIXED REALITY VIRTUAL DESKTOP DISPLAY ZONE, KEYBOARD ZONE, AND ENVIRONMENTAL ZONE

(71) Applicant: Dell Products LP, Round Rock, TX (US)

(72) Inventors: Loo Shing Tan, Singapore (SG); Michiel Sebastiaan Emanuel Petrus Knoppert, Amsterdam (NL); Gerald Rene Pelissier, Santa Clara, CA (US); Jarrett Simerson, Northbrook, IL (US)

(73) Assignee: Dell Products LP, Round Rock, TX (US)

(21) Appl. No.: 19/196,325

(22) Filed: May 1, 2025

(51) Int. Cl. G06F 3/023; G06F 1/16; G06F 3/01; G06F 3/02; G06F 3/04883; G06T 11/00; G06V 20/20; G06V 40/20

(52) U.S. Cl. CPC G06F 3/023; G06F 3/012; G06F 3/017; G06F 3/0227; G06F 3/04883; G06T 11/00; G06V 20/20; G06V 40/28; G06F 1/163; G06F 2203/04803

(57) ABSTRACT

An augmented reality/mixed reality (AR/MR) control computing device comprises a port for receiving captured images of a wall plane and keyboard planar surface taken from a defined glasses anchor fixed to a position of operatively coupled AR/MR glasses, and a hardware processor executing machine readable code instructions to generate a mixed reality workspace ecosystem in a physical user workspace to navigate an intuitive virtual workspace topology including a keyboard zone defined by a hardware device anchor of the keyboard planar surface, and a virtual desktop display zone within a modeled surface around a virtual desktop display zone anchor, and an environmental zone defined by a structure anchor oriented to the wall plane, and generate and navigate digital images, based on position and orientation of the structure anchor, device anchor, and desktop zone anchor with respect to the glasses anchor, for display via the AR/MR glasses within the intuitive virtual workspace topology.

### FIELD OF THE DISCLOSURE

The present disclosure generally relates to augmented reality (AR) or mixed reality (MR) glasses or headsets that operatively couple with an AR/MR control computing device information handling system to display media to a user within a mixed reality workspace ecosystem of hardware devices. The present disclosure more specifically relates to a system and method for displaying digital content via an intuitive virtual workspace topology surrounding the user, a keyboard, or touch drawing pad within a user workspace, that includes multiple MR zones and hardware and gesture detection for various types of user interaction, including an environmental zone fixed to and coplanar with a nearby structure, such as a wall, a keyboard zone surrounding and anchored with the keyboard or other hardware device, and a virtual desktop display zone surrounding the user and oriented at a user-specified distance from the AR/MR glasses.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities. The information handling system may be operatively or wirelessly coupled to a digital display device, such as AR/MR glasses, for output of images or sound of digital media generated by one or more software applications for a user.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an augmented reality/mixed reality (AR/MR) control computing device information handling system in a mixed reality workspace ecosystem of hardware devices executing machine readable code instructions to generate and orchestrate the display of AR/MR images via operably coupled AR/MR glasses in functional zones according to an embodiment of the present disclosure;

FIG. 2 is a graphical diagram illustrating a user workspace environment including the AR/MR control computing device information handling system operatively coupled to AR/MR glasses and a plurality of input/output (IO) devices for support of a mixed reality workspace ecosystem of hardware devices according to an embodiment of the present disclosure;

FIG. 3 is a graphical diagram illustrating a user workspace environment with an intuitive virtual workspace topology including a desktop zone, a keyboard zone, and an environmental zone forming a mixed reality workspace ecosystem of hardware devices including an AR/MR control computing device information handling system operatively coupled to AR/MR glasses according to an embodiment of the present disclosure;

FIG. 4A is a graphical diagram illustrating a top view of a mixed reality workspace ecosystem of hardware devices with a cylindrical virtual desktop display zone fixed to and centered upon a glasses view anchor of the AR/MR glasses for the display of software application windows according to an embodiment of the present disclosure;

FIG. 4B is a graphical diagram illustrating a top view of a mixed reality workspace ecosystem of hardware devices with a user-selected elliptical virtual desktop display zone having a virtual desktop display zone anchor set at a user-specified distance from a glasses view anchor of AR/MR glasses for the display of software application windows according to an embodiment of the present disclosure;

FIG. 4C is a graphical diagram illustrating a top view of mixed reality workspace ecosystem of hardware devices with a user-selected cylindrical virtual desktop display zone having a virtual desktop display zone anchor set at a user-specified distance from a glasses view anchor of AR/MR glasses for the display of software application windows according to an embodiment of the present disclosure;

FIG. 5A is a graphical diagram illustrating a mixed reality workspace ecosystem of hardware devices with a virtual desktop display zone and a keyboard zone as projected and viewed from AR/MR glasses for the display of software application windows and interactive widget icons in an intuitive virtual workspace topology according to an embodiment of the present disclosure;

FIG. 5B is a graphical diagram illustrating a top view of a mixed reality workspace ecosystem of hardware devices with user gesturing to adjust the display of various software application window sub-workspaces of a virtual desktop display zone in an intuitive virtual workspace topology according to an embodiment of the present disclosure;

FIG. 5C is a graphical diagram illustrating an AR/MR glasses view of mixed reality workspace ecosystem of hardware devices with a user providing user input to move the display of a software application window from a virtual desktop display zone to a keyboard zone in an intuitive virtual workspace topology according to an embodiment of the present disclosure;

FIG. 5D is a graphical diagram illustrating the AR/MR glasses view of mixed reality workspace ecosystem of hardware devices with the display of the software application window moved from the virtual desktop display zone to the keyboard zone in the intuitive virtual workspace topology according to an embodiment of the present disclosure;

FIG. 6A is a graphical diagram illustrating plural magnetic pen sensors in a keyboard or a touch drawing pad detecting movement of a magnetic pen input/output (IO) device in a keyboard zone of an intuitive virtual workspace topology of a mixed reality workspace ecosystem of hardware devices according to an embodiment of the present disclosure;

FIG. 6B is a graphical diagram illustrating display of a magnetic pen ink image having a pattern following received movement of a magnetic pen IO device within a keyboard zone in an intuitive virtual workspace topology of a mixed reality workspace ecosystem of hardware devices according to an embodiment of the present disclosure;

FIG. 6C is a graphical diagram illustrating a perspective view of a user workspace for a mixed reality workspace ecosystem of hardware devices with detected tapping of a user on a desk, via an accelerometer, to provide user input to a software application window in an intuitive virtual workspace topology according to an embodiment of the present disclosure;

FIG. 6D is a graphical diagram illustrating an AR/MR glasses view of a display of a virtual input/output device in a keyboard zone receiving user input in the form of a detected hand gesture or user tapping user input to a software application window in an intuitive virtual workspace topology according to an embodiment of the present disclosure;

FIG. 7 is a flow diagram illustrating a method of modeling and display of digital images within a virtual desktop display zone, a virtual keyboard zone, and a virtual environmental zone of an intuitive virtual workspace topology for interaction by a user in a mixed reality workspace ecosystem of hardware devices according to an embodiment of the present disclosure; and

FIG. 8 is a flow diagram illustrating a method of processing user input in a mixed reality workspace ecosystem of hardware devices indicating interaction with digital images displayed within the environmental zone, the keyboard zone, or the virtual desktop display zone of an intuitive virtual workspace topology with hardware devices or gestures according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

As computing processing capabilities grow, so too does a need for more room to display content for user interaction, such as across a plurality of digital display devices, for example.

Another solution to such a need is to combine digital display devices with augmented reality or mixed reality (AR/MR) glasses within a user workspace environment that can further display holographic projected images of digital content, either in combination with, or in place of digital display devices such as computer monitors. Simultaneously, changes in working environments require that users be flexible to work in different locales, such as within the office, the home, public spaces, or on the move meaning user workspace environments may change. Users desire the same computing experience and level of privacy that they enjoy in more controlled environments, such as their home or their office, across each of these potential working locales. Use of AR/MR glasses can provide private, repeatable, location independent user experiences, and relieve physical world limitations, such as screen sizes of physical screens.

Using AR/MR glasses allows users to organize a virtual workspace in the user workspace environment around themselves, projected on top of the real world to create a more immersive workspace making use of the physical space around them. Interactions in this user workspace environment with the virtual workspace may use familiar peripherals such as a keyboard, touchpad, and a mouse, for easy adoption and support for existing applications, however organization of displayed images for windows or virtual icons may be haphazard and non-intuitive. According to embodiments of the present disclosure, using AR/MR glasses and MR projection, a hardware processor executing machine readable code instructions of an AR/MR workspace topology tracking and display orchestration system to generate a plurality of display and user interaction mixed reality (MR) zones in an intuitive virtual workspace topology forming a mixed reality workspace ecosystem of hardware devices for intuitive navigation by a user. In embodiments herein the intuitive virtual workspace topology includes a virtual desktop display zone presented as an elliptical surface surrounding the user's head at eye-level, a keyboard zone surrounding the keyboard at a location closer than the virtual desktop display zone for the display of projected images representing a taskbar, function row, or virtual widget icons, and an environmental zone fixed to and coplanar with a nearby static structure, such as a wall, for the display of ornamental images, such as paintings, for example, or various background widgets, such as weather widgets, for example.

A hardware processor of an AR/MR control computing device operatively coupled to AR/MR glasses in embodiments herein may execute machine readable code instructions of a position tracking module of the AR/MR workspace topology tracking and display orchestration system to define a position and orientation of a physical plane perspective anchor modeled to be fixed to and coplanar with an identified planar surface of a static structure, such as a wall, as seen within digital images captured by a camera of the AR/MR glasses at a glasses view anchor and which may be fixed within a modeled world map of structures, furniture, the user, and IO devices. The hardware processor of the AR/MR control computing device in embodiments herein may also execute machine readable code instructions of the position tracking module of the AR/MR workspace topology tracking and display orchestration system to identify a hardware device anchor fixed to and coplanar with an identified operatively coupled keyboard or other hardware device, as also seen within the digital images captured by the AR/MR glasses camera, for orienting projected images of virtual widget icons or software application windows or other projected images within a keyboard zone and fixed to a digital device. Finally, the hardware processor of the AR/MR control computing device in embodiments herein may also execute machine readable code instructions of the position tracking module for the AR/MR workspace topology tracking and display orchestration system to define a virtual desktop display zone anchor having a fixed distance from the AR/MR glasses view anchor around which an elliptical surface may be modeled for the display of the user's desktop windows at a viewing distance from the user. It is contemplated that the elliptical surface may include a cylindrical shaped surface, an extended ellipse shaped surface, a stadium shaped surface (e.g., a rectangle with semi-circular ends) or others around a user's position in an virtual desktop display zone of the intuitive virtual workspace topology of embodiments herein. The user may select among elliptical shapes of the modeled elliptical surface via user input received from the user at a control graphical user interface displayed via the AR/MR glasses. The viewing distance of a AR/MR glasses viewing anchor from the projected elliptical surface and relative to the virtual desktop display zone anchor may be previously set by the user as a comfortable viewing distance in some embodiments. In embodiments, the hardware processor of the AR/MR control computing device may execute machine readable code instructions of a digital images graphics generation module and an augmented projected images transformation module to generate and adjust an image shape, size, position or viewing angle of generated digital images, based on position and orientation of projected images relative to the physical plane anchor, the hardware device anchor, or the virtual desktop display zone anchor and with respect to the glasses view anchor, for display via the AR/MR glasses within the environmental zone, the keyboard zone, or the virtual desktop display zone, respectively.

The user may also be able to interact with digital images displayed within the environmental zone, the keyboard zone, or the virtual desktop display zone in organized and defined locations within an intuitive virtual workspace topology for intuitive navigation within and between the virtual desktop display zone, the keyboard zone, and the environmental zone with hardware devices in a mixed reality workspace ecosystem. That navigation may be intuitively conducted by a user within the intuitive virtual workspace topology in the mixed reality workspace ecosystem with hardware devices that may include one or more operatively coupled input/output (IO) devices, such as a mouse or magnetic pen, for example, or through recognized user gesture or tapping on the desk supporting the keyboard or touch drawing pad in embodiments herein. For example, the user may use one or more IO devices or hand gestures to group software application windows displayed within the virtual desktop display zone into software application window sub-workspaces, each oriented at a different position within the elliptical surface of the virtual desktop display zone, and each having a digital thumbnail image displayed within a taskbar of the keyboard zone, or to scroll among them. As another example, movement of a magnetic pen may be sensed by magnetic sensors within the keyboard or touch drawing pad and the hardware processor of the AR/MR control computing device may execute machine readable code instructions of the digital images graphics generation module and the augmented projected images transformation module to generate and adjust a magnetic pen ink image shape, size, position or viewing angle of virtual ink having a pattern following the received movement of the magnetic pen, relative to the position and orientation of the hardware device anchor and with respect to the glasses view anchor, for display via the AR/MR glasses within the keyboard zone. In still another example, the hardware processor of the AR/MR control computing device may execute machine readable code instructions of the augmented projected images transformation module to readjust the shape, size, position, or viewing angle of a generated digital image representing a software application window that an identified user command has dragged from the virtual desktop display zone to the virtual keyboard zone, and to display the image within the virtual keyboard zone or vice-versa.

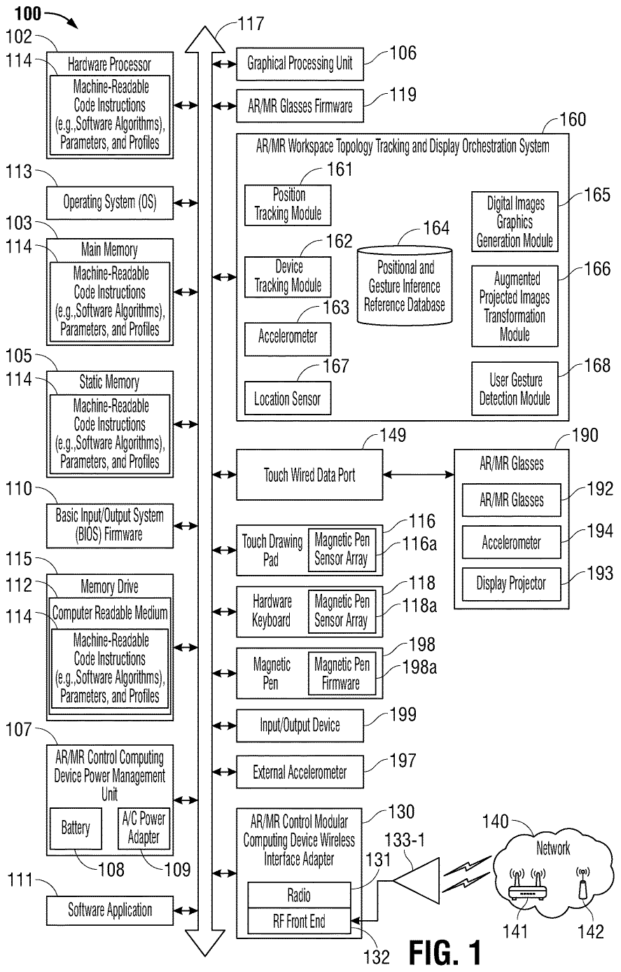

Turning now to the figures, FIG. 1 illustrates an information handling system 100 similar to the information handling systems according to several aspects of the present disclosure. A mixed reality workspace ecosystem with hardware devices includes an ecosystem of devices of a mobile user workspace are described in an embodiment herein, which include AR/MR glasses 190 operatively coupled to an AR/MR control computing device 100 for generating and orchestrating the display of digital content within the AR/MR glasses 190 using the display projector electronics 193 to intuitively navigate an intuitive virtual workspace topology projected with the AR/MR glasses 190. The information handling system operating as an AR/MR control computing device 100 in an embodiment may be operably coupled to one or more external input/output devices 199, a touch drawing pad 116, a keyboard device 118, a mouse or pointer device or other external/input output devices (not shown) in various user workspaces, via wired or wireless connection, for example. In an embodiment, power and data may be transferred via a wired data port 149 between the AR/MR glasses 190 and the AR/MR control computing device 100, via the touch drawing pad 116, or the keyboard 118. The wired data port 149 in an embodiment may comprise a universal serial bus (USB) data port, such as a USB-C port, for example. The AR/MR control computing device 100 may allow power transfer or transfer of data, via the wired data port 149.

The wired data port 149 may be operatively coupled with a bus 117 of the AR/MR control computing device 100 in an embodiment for the transfer of power and data between the AR/MR control computing device 100 and the AR/MR glasses 190. In a further embodiment, a wired data transfer connection via the AR/MR glasses 190 may be established between the AR/MR glasses 190 and the touch drawing pad 116 or the keyboard 118, which may house the AR/MR control computing device 100 or be operatively coupled thereto via wired or wireless connection. The touch drawing pad 116 operatively coupled with or combined with the keyboard 118 and housing the AR/MR control computing device 100 forms a new and efficient form of information handling system suited to operate with AR/MR glasses for navigating within the intuitive virtual workspace topology within and between the virtual desktop display zone, the keyboard zone, and the environmental zone with hardware devices in a mixed reality workspace ecosystem according to embodiments herein.

The wired data transfer connection via the AR/MR glasses and AR/MR control computing device 100 may be established for the transfer of captured images from a camera 192 of the AR/MR glasses 190, positional telemetry gathered by an accelerometer 194 of the AR/MR glasses 190, and display data from the AR/MR control computing device 100 executing machine readable code instructions of software applications 111 or firmware applications 119 for directing the display of generated AR/MR images at the display projector 193 of the AR/MR glasses 190 in embodiments herein. For example, the hardware processor 102 or graphical processing unit (GPU) 106 may execute machine readable code instructions of AR/MR glasses firmware 119 or software applications 111 to generate and display AR or MR projected images via a display projector 193 within the operatively coupled AR/MR glasses 190.

A user wearing the AR/MR glasses 190 in an embodiment may situate themselves in an user physical workspace environment that includes the AR/MR control computing device 100 incorporated within a keyboard 118 or touch drawing pad 116 housing in embodiments herein. The user may choose a world view anchor, based on an initial position of the AR/MR glasses 190 that may serve as a reference point for the establishment of an intuitive virtual workspace topology surrounding the user, keyboard 118, and touch drawing pad 116, and that includes multiple MR zones for various types of intuitive user interaction, including a keyboard zone, a desktop zone, and an environmental zone to form the mixed reality workspace ecosystem with hardware devices of embodiments herein. Sensors, such as accelerometer 194 within the AR/MR glasses 190 in an embodiment at may continuously track movement of the AR/MR glasses 190 with respect to a world view coordinate system anchor fixed in there-dimensional space to an original or initial recorded position of the AR/MR glasses 190. This provides a glasses view virtual coordinate system anchor having a position that varies over time with respect to the world view coordinate system anchor for providing references to generate or model the intuitive virtual workspace topology for intuitive navigation within and between the virtual desktop display zone, the keyboard zone, and the environmental zone with hardware devices in a mixed reality workspace ecosystem relative to the AR/MR glasses 190.

A camera 192 in the AR/MR glasses 190 in an embodiment may capture one or more images of surrounding structures, furniture, keyboard 118, touch drawing pad 116, user's hands, and various operatively coupled input/output (IO) devices 199, as viewed from the glasses view anchor. The hardware processor 102 of the AR/MR control computing device 100 in an embodiment may execute machine readable code instructions 114 of a position tracking module 161 for the AR/MR workspace topology tracking and display orchestration system 160 to identify static and unmoving surrounding structures, or furniture, such as a desk, as well as positions of these structures with respect to the glasses view anchor and world view anchor, to create a virtual rendering of a world map of structures and furniture surrounding the AR/MR glasses 190 in the physical user workspace and represented in digital images captured by the camera 192.

The hardware processor 102 in an embodiment may also determine whether the generated world map of surrounding structures and furniture matches a previously stored world map within the positional and gesture inference reference database 164 stored in memory 103, 105, or 115 of the AR/MR control computing device 100. This may involve comparison of captured images forming the basis of the virtual rendering of the world map with previously captured digital images of the same room, for example, as stored within the positional gesture and inference reference database 164 and previously associated with a previously stored world map. Such stored world maps may further include previously determined and defined boundaries, orientations, and anchors for various structures, such as walls, or static furniture, such as desks within the user's routinely used workspace, in which the user wishes to currently establish an intuitive virtual workspace topology for intuitive navigation within and between the virtual desktop display zone, the keyboard zone, and the environmental zone with hardware devices in a mixed reality workspace ecosystem. If the recently generated world map matches a previously stored world map, this may indicate that the user is attempting to establish the intuitive virtual workspace topology in a room or area in which this process has previously been performed.

In such a case, the hardware processor 102 in an embodiment may execute machine readable code instructions 114 of the position tracking module 161 to retrieve one or more previously identified and stored physical plane anchors that each define a center point and orientation of a physical planar surface (e.g., wall, desk) with respect to the world view anchor. This physical plane anchor may be used to model an environmental zone that is co-planar with the structural planar surface and fixed to the physical plane anchor, based on previously determined positions and orientations of the static structure with respect to the world view anchor. Similarly, the retrieved one or more previously identified and stored hardware device anchors that each define a hardware device location and orientation of a hardware device (e.g., keyboard 118 or touch drawing pad 116) with respect to the world view anchor. This one or more hardware device anchors may be used to model keyboard zone that is co-planar with the structural planar surface such as a desk and fixed to the physical hardware device, based on previously determined positions and orientations of the static structure such as the desk and location of the hardware device with respect to the world view anchor. Finally, the retrieved one or more previously identified and stored virtual desktop display zone anchors that each define a user world view location from AR/MR glasses relative to the glasses view anchor location for positioning of the virtual desktop display zone with respect to the world view anchor.

In an embodiment in which the recently generated world map does not match a previously stored world map in the positional and gesture inference reference database 164, the hardware processor 102 of the AR/MR control computing device 100 may execute machine readable code instructions 114 of the position tracking module 161 for the AR/MR workspace topology tracking and display orchestration system 160 to identify physical structures, such as walls, and generate one or more physical plane anchors that each define a center point and orientation of a physical planar surface (e.g., wall, desk) with respect to the world view anchor. This may be achieved by the hardware processor 102 of the AR/MR control computing device 100 may execute machine readable code instructions 114 of the position tracking module 161 to compare digital images of the surrounding structures to stock device reference images stored in the positional and gesture inference reference database 161 to identify the static structure, such as a wall, and orientation of the structure planar surface with respect to the glasses view anchor.

A hardware processor 102 of the AR/MR control computing device 100 in an embodiment may execute machine readable code instructions 114 of a position tracking module 161 for a desk location and a device tracking module 162 for the AR/MR workspace topology tracking and display orchestration system 160 to compare images captured by the camera 192 to device reference images stored in the positional and gesture inference reference database 164 to identify the desk surface as well as hardware devices such as the keyboard 118, the touch drawing pad 116, and any other operatively coupled IO devices 199. This may include identification of distances, angles, and orientations of these devices 116, 118, 198, and 199 with respect to the glasses view anchor and world view anchor for generating a keyboard zone in the intuitive virtual workspace topology of the mixed reality workspace ecosystem. In an embodiment, the hardware processor 102 may execute machine readable code instructions 114 of the device tracking module 162 to identify one or more hardware device anchors that each define a center point and orientation of an identified IO device 116, 118, 198, or 199 with respect to the world view anchor or glasses view anchor in generating the projected keyboard zone for the intuitive virtual workspace topology of the mixed reality workspace ecosystem. Additionally, the hardware processor 102 may execute machine readable code instructions 114 of the position tracking module 161 and the device tracking module 162 to identify one or more virtual desktop display zone anchors that each define a center point and orientation of as static viewing location for an elliptical surface of the virtual desktop display zone in an embodiment. For example, the virtual desktop display zone anchors may be based off of a world view anchor relative to an AR/MR glasses anchor for generating and projecting an elliptical virtual desktop display zone with respect to the world view anchor and movement of the glasses view anchor in the intuitive virtual workspace topology of the mixed reality workspace ecosystem in embodiments herein.

The hardware processor 102 may execute machine readable code instructions 114 to model an environmental zone that is co-planar with the structural planar surface and fixed to the physical plane anchor, a keyboard zone that is co-planar with the keyboard planar surface and fixed to the hardware device anchor, and a virtual desktop display zone within a modeled cylindrical virtual desktop display zone surface at least partially surrounding the user that is fixed to a virtual desktop display zone anchor. In an embodiment, the hardware processor 102 may execute machine readable code instructions 114 of the position tracking module 161 to model a virtual elliptical surface surrounding the user having a virtual desktop display zone anchor at a defined distance and orientation with respect to the glasses view anchor fixed to the AR/MR glasses 190, depending on previously provided user preferences for virtual desktop display zone distance and elliptical shape received from the user. It is contemplated that the projected elliptical surface may include a cylindrical shaped surface, an extended ellipse shaped surface, a stadium shaped surface (e.g., a rectangle with semi-circular ends) or others around a user's position in an virtual desktop display zone of the intuitive virtual workspace topology of embodiments herein. Further, the viewable projected elliptical surface as viewable from the AR/MR glasses 190 may surround the user's position partially or fully. The user may select among elliptical shapes of the modeled elliptical surface via user input received from the user at a control graphical user interface generated by the hardware processor 190 and displayed via the AR/MR glasses 190. The hardware processor 102 may execute machine readable code instructions 114 of a digital images graphics generation module 165 to generate digital images for display via the AR/MR glasses 190 within the virtual desktop display zone centered upon and oriented by the virtual desktop display zone anchor, within the virtual keyboard zone centered upon and oriented by one of the hardware device anchors, and within the virtual environmental zone centered upon and oriented by one or more of the physical plane anchors. The hardware processor 102 in an embodiment may execute machine readable code instructions 114 of an augmented projected images transformation module 166 to adjust the shape, size, position, or viewing angle of the generated digital images and to instruct the AR/MR glasses 190 to display them within the modeled virtual desktop display zone, virtual keyboard zone, or virtual environmental zone, based on positions of the virtual desktop display zone anchor, one or more hardware device anchors, or one or more physical plane anchors with respect to the world view anchor and glasses view anchor of the AR/MR glasses 190 as they move, respectively.

As described herein, the user in an embodiment may interact with digital images intuitively displayed within the environmental zone, the keyboard zone, or the virtual desktop display zone, via one or more operatively coupled input/output (IO) devices 116, 118, 198, or 199, or through recognized user gesture or tapping on the desk supporting the keyboard 118 or touch drawing pad 116. A user in an embodiment may interact with the two-dimensional generated images representing software application 111 windows projected onto a modeled elliptical virtual desktop display zone via AR/MR glasses 190, as described directly above, using IO devices 116, 118, 198, or 199 operatively coupled to the AR/MR control computing device 100. The user may use one or more operatively coupled IO devices, such as 116, 118, 198, or 199 to group software application 111 projected operational windows into software application window sub-workspaces, each oriented at a different position within the elliptical virtual desktop display zone. Upon such a grouping, for example, the hardware processor 102 may execute machine readable code instructions 114 of the digital images graphics generation module 165 to generate a plurality of thumbnail images, each representing a grouped subset of the one or more software application 111 projected operational windows. The hardware processor 102 may also execute machine readable code instructions 114 of the augmented projected images transformation module 166 to adjust the shape, size, position, or viewing angle of the generated taskbar digital images for display within the taskbar of the virtual keyboard zone and to orchestrate display of the plurality of thumbnail image virtual icons within a virtual taskbar projected for display within the keyboard zone. One of the plurality of software application window sub-workspaces may be displayed, via the hardware processor 102 executing machine readable code instructions 114 of the augmented projected images transformation module 166 directing display from the display projector 193 of the one of the plurality of software application window sub-workspaces at a user-specified, front-facing location within the virtual desktop display zone. Further, AR/MR glasses camera 192 may detect user gestures may select or change the plurality of software application window sub-workspaces at the user-specified, front-facing location.

The AR/MR glasses camera 192 in some embodiments may capture images of the user's hands as they interact with physical IO devices 116, 118, 198, or 199 or images projected within one or more of the environmental zone, keyboard zone, or desktop zone, via the AR/MR glasses 190. The hardware processor 102 may execute machine readable code instructions 114 of the user gesture detection module 168 to identify a user gesture command or a user input received via an IO device 199, such as a mouse, to move one of the plurality of software application 111 projected operational windows displayed within the virtual desktop display zone to the keyboard zone, based on identification of pose, position, or movement of a user's hand within the plurality of images captured via the camera 192. This may be achieved by the hardware processor 102 executing machine readable code instructions 114 of the user gesture detection module 168, to compare captured images of user hands against stored gesture inference images in the positional and gesture inference reference database 164 to identify a user command gesture. In such an embodiment, the hardware processor 102 may execute machine readable code instructions 114 of the augmented projected images transformation module 166 to readjust a software application 111 operational window image shape, size, position or viewing angle, based on position and orientation of the hardware device anchor with respect to the glasses view anchor, for display within the keyboard zone.

In another aspect of an embodiment, a detected hand gesture may be combined with a sensor indicator of a user tapping on a desk to provide user input for interaction with a software application 111 operational window or virtual IO device. An accelerometer within the keyboard 118 or touch drawing pad 116 or a standalone external accelerometer 197 in an embodiment may identify a user tapping on the desk within a virtual desktop display zone. In such an embodiment, the hardware processor 102 may execute machine readable code instructions 114 to also identify a user gesture command for user input to one of the plurality of software application windows displayed within the keyboard zone, as described directly above. In response to both of these received inputs, the hardware processor 102 may execute machine readable code instructions 114 to generate and adjust an updated image shape, size, position or viewing angle of the digital image of the software application 111 operational window, based on the received user input and position and orientation of the hardware device anchor with respect to the glasses view anchor, for display via the AR/MR glasses 190 within the keyboard zone. For example, the hardware processor 102 in an embodiment may associate the received user input with an input or command instruction for interaction with the software application 111.

The hardware processor 102 may also execute machine readable code instructions 114 of the user gesture detection module 168, or magnetic pen firmware 198a to associate an identified user command gesture, magnetic pen 198 usage, or user tap with a command instruction for interaction with a software application 111 operational window, virtual widget icon, virtual IO device, or ornamental image represented by a projected image displayed within the virtual desktop display zone, the virtual keyboard zone, or the virtual environmental zone. For example, the AR/MR control computing device 100 may receive magnetic pen positional telemetry from the magnetic pen 198 identifying movement of an operatively coupled magnetic pen 198 with respect to the hardware device anchor. In such an embodiment, the hardware processor 102 may execute machine readable code instructions of the digital images graphics generation module 165 to generate a magnetic pen ink image having a pattern following the received movement of the magnetic pen. The hardware processor 102 may also execute machine readable code instructions of the augmented projected images transformation module 166 to adjust the shape, size, position or viewing angle of the magnetic pen ink image, based on the position and orientation of the hardware device anchor with respect to the glasses view anchor, for display via the AR/MR glasses 190 within the keyboard zone.

In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP) 141, a base station transceiver 142, a wireless telephone, a control system, a camera, a scanner, a printer, a personal trusted device, a web appliance, or any other suitable machine capable of executing a set of instructions (sequential or otherwise) that specify actions to be taken by that machine, and may vary in size, shape, performance, price, and functionality.

In a networked deployment, the information handling system 100 may operate in the capacity of a client computer in a server-client network environment, or as a peer computer system in a peer-to-peer (or distributed) network environment. In an embodiment, the information handling system 100 may be implemented using electronic devices that provide voice, video, or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or plural sets, of computer readable code instructions to perform one or more computer functions, via one or more hardware processing resources.

The information handling system operating as the AR/MR control computing device 100 may include main memory 103, (volatile (e.g., random-access memory, etc.), or static memory 105, nonvolatile (read-only memory, flash memory etc.) or any combination thereof), one or more hardware processing resources, such as a hardware processor 102 that may be a central processing unit (CPU), a graphics processing unit (GPU) 106, other hardware controllers, or any combination thereof. Additional components of the information handling system operating as the AR/MR control computing device 100 may include one or more storage devices such as static memory 105 or drive unit 115. The information handling system operating as the AR/MR control computing device 100 may include or interface with one or more communications ports for communicating with external devices, as well as one or more input/output (IO) devices 199, a video/graphics digital display device, or any combination thereof. Portions of an information handling system 100 may themselves be considered information handling systems 100.

Information handling system operating as the AR/MR control computing device 100 may include devices or modules that embody one or more of the hardware devices or hardware processing resources executing machine readable code instructions for one or more systems and modules. The information handling system operating as the AR/MR control computing device 100 may execute machine readable code instructions (e.g., software or firmware algorithms), parameters, and profiles 114 that may operate on servers or systems, remote data centers, or on-box in individual client information handling systems according to various embodiments herein. In some embodiments, it is understood any or all portions of machine readable code instructions (e.g., software or firmware algorithms), parameters, and profiles 114 may operate on a plurality of information handling systems operating as the AR/MR control computing device 100.

The information handling system operating as the AR/MR control computing device 100 may include the hardware processor 102 such as a central processing unit (CPU) or other hardware processing resources on the AR/MR control computing device 100. Any of the hardware processing resources may operate to execute machine readable code instructions 114 that are either firmware or software code. The hardware processor 102 in the AR/MR control computing device 100 may comprise a vector CPU or multi-vector CPU or may be a graphics processing unit (GPU) 106 or other hardware processing resource. Hardware processor 102, GPU 106 or other hardware processing resources may execute machine readable code instructions 114 of the AR/MR workspace topology tracking and display orchestration system 160, one or more software applications 111 or AR/MR glasses firmware 119 in embodiments herein to generate digital display data or location determination data for AR/MR glasses 190, a digital display device or other input/output device 199 according to various embodiments herein.

Moreover, the information handling system operating as the AR/MR control computing device 100 may include memory such as main memory 103, static memory 105, and disk drive unit 115 (volatile (e.g., random-access memory, etc.), nonvolatile memory (read-only memory, flash memory etc.) or any combination thereof or other memory with computer readable medium 112 storing machine readable code instructions (e.g., software or firmware algorithms), parameters, and profiles 114 executable by the hardware processor 102, GPU 106, or any other hardware processing device. The information handling system 100 may also include one or more buses 117 operable to transmit communications between the various hardware components such as any combination of various I/O devices 199, as well as between hardware processors 102, GPU 106 or other, the operating system (OS) 113, the basic input/output system (BIOS) 110, the wireless interface adapter 130, or a radio module 131, among other components described herein. In an embodiment, the hardware processor 102, and/or GPU 106 may execute one or more bus drivers in order to transmit this data between the information handling system operating as the AR/MR control computing device 100 and the input/output devices 199 described herein.

A network interface device 130 of the information handling system operating as the AR/MR control computing device 100 may be wired or wireless such as shown with wireless interface adapter 130 that can provide wireless connectivity among devices such as with Bluetooth® or to a network 140, e.g., a wide area network (WAN), a local area network (LAN), wireless local area network (WLAN), a wireless personal area network (WPAN), a wireless wide area network (WWAN), or other network. In embodiments described herein, the wireless interface device 130 with its radio 131, RF front end 132 and antenna 133 is used to communicate with the network 140, via, for example, a Bluetooth® or Bluetooth® Low Energy (BLE) protocols, or other WPAN or WLAN protocols.

In an embodiment, a WAN, WWAN, LAN, and WLAN may each include an AP 141 or base station 142 used to operatively couple the information handling system operating as the AR/MR control computing device 100, via a wireless interface adapter 130. In a specific embodiment, the network 140 may include macro-cellular connections via one or more base stations 142 or a wireless AP 141 (e.g., Wi-Fi), or such as through licensed or unlicensed WWAN small cell base stations 142. Connectivity may be via wired or wireless connection. For example, wireless network wireless APs 141 or base stations 142 may be operatively connected to the information handling system operating as the AR/MR control computing device 100. Wireless interface adapter 130 may include one or more radio frequency (RF) subsystems (e.g., radio 131) with transmitter/receiver circuitry, modem circuitry, one or more antenna RF front end circuits 132, one or more wireless controller circuits, amplifiers, antennas 133, and other circuitry of the radio 131, such as one or more antenna ports used for wireless communications via multiple radio access technologies (RATs). The radio 131 may communicate with one or more wireless technology protocols.

In an embodiment, the wireless interface adapter 130 may operate in accordance with any wireless data communication standards. To communicate with a wireless local area network, standards including IEEE 802.11 WLAN standards (e.g., IEEE 802.11ax-2021 (Wi-Fi 6E, 6 GHZ)), IEEE 802.15 WPAN standards, WiMAX, WWAN such as 3GPP or 3GPP 2, Bluetooth® standards, proprietary RF protocol, or similar wireless standards may be used. Utilization of radiofrequency communication bands according to several example embodiments of the present disclosure may include bands used with the WLAN standards which may operate in both licensed and unlicensed spectrums. For example, WLAN may use frequency bands such as those supported in the 802.11 a/h/j/n/ac/ax/be including Wi-Fi 6, Wi-Fi 6e, and the emerging Wi-Fi 7 standard. It is understood that any number of available channels may be available in WLAN under the 2.4 GHZ, 5 GHZ, or 6 GHz bands which may be shared communication frequency bands with WWAN protocols or Bluetooth ® protocols in some embodiments. Wireless interface adapter 130 may connect to any combination of macro-cellular wireless connections including 2G, 2.5G, 3G, 4G, 5G or the like from one or more service providers. Utilization of RF communication bands according to several example embodiments of the present disclosure may include bands used with the WLAN standards and WWAN carriers which may operate in both licensed and unlicensed spectrums. The wireless interface adapter 130 can represent an add-in card, wireless network interface module that is integrated with a main board of the information handling system operating as the AR/MR control computing device 100 or integrated with another wireless network interface capability, or any combination thereof.

In some embodiments, one or more hardware processors or hardware controllers executing software, firmware, or dedicated hardware implementations such as application specific integrated circuits, programmable logic arrays and other hardware devices may be constructed to implement one or more of some systems and methods described herein.

Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by firmware or software machine readable code instructions executable by a hardware controller or a hardware processor system. Further, in an exemplary, non-limited embodiment, implementations may include distributed hardware processing, component/object distributed hardware processing, and parallel hardware processing.

Alternatively, virtual computer system processing may be constructed to implement one or more of the methods or functionalities as described herein.

The present disclosure contemplates a computer-readable medium 112 that includes machine-readable code instructions, parameters, and profiles 114 or receives and executes instructions, parameters, and profiles 114 responsive to a propagated signal, so that a hardware device connected to a network 140 may communicate voice, video, or data over the network 140. Further, the machine readable code instructions 114 may be transmitted or received over the network 140 via the network interface device or wireless interface adapter 130. The information handling system 100 may include a set of instructions 114, that may be executed to cause the AR/MR control computing device 100 to perform any one or more of the methods or computer-based functions disclosed herein. For example, machine readable code instructions 114 may be executed by a hardware processor 102, GPU 106, or any other hardware processing resource and may include software agents, or other aspects or components used to execute the methods and systems described herein. Various software application modules 111 or firmware modules (e.g., AR/MR glasses firmware 119) comprising application machine readable code instructions 114 may be coordinated by an OS 113, and/or via an application programming interface (API) include a unified device API described herein. An example OS 113 may include Windows®, Android®, and other OS types. Example APIs may include Win 32, Core Java API, or Android APIs.

In an embodiment, the information handling system operating as the AR/MR control computing device 100 may include a disk drive unit 115. The disk drive unit 115 may include machine-readable code instructions, parameters, and profiles 114 in which one or more sets of machine-readable code instructions, parameters, and profiles 114 such as firmware or software can be embedded to be executed by the hardware processor 102 or other hardware processing devices such as a GPU 106, or other microcontroller unit to perform the processes described herein. Similarly, main memory 103 and static memory 105 may also contain a computer-readable medium for storage of one or more sets of machine-readable code instructions, parameters, or profiles 114 described herein. The disk drive unit 115 or static memory 105 also contain space for data storage. Further, the machine-readable code instructions, parameters, and profiles 114 may embody one or more of the methods as described herein. In a particular embodiment, the machine-readable code instructions, parameters, and profiles 114 may reside completely, or at least partially, within the main memory 103, the static memory 105, and/or within the disk drive 115 during execution by the hardware processor 102, or GPU 106 of information handling system 100.

Main memory 103, or other memory of the embodiments described herein may contain computer-readable medium (not shown), such as RAM in an example embodiment. An example of main memory 103 includes random access memory (RAM) such as static RAM (SRAM), dynamic RAM (DRAM), non-volatile RAM (NV-RAM), or the like, read only memory (ROM), another type of memory, or a combination thereof. Static memory 105 may contain computer-readable medium (not shown), such as NOR or NAND flash memory in some example embodiments. The applications and associated APIs, for example, may be stored in static memory 105 or on the disk drive unit 115 that may include access to a machine-readable code instructions, parameters, and profiles 114 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system operating as the AR/MR control computing device 100 may further include a power management unit (PMU) 107 (a.k.a. a power supply unit (PSU)). The PMU 107 may include a hardware controller and executable machine-readable code instructions to manage the power provided to the components of the information handling system operating as the AR/MR control computing device 100 such as the hardware processor 102 and other hardware components described herein. The PMU 107 may control power to one or more components including the one or more drive units 115, the hardware processor 102 (e.g., CPU), the GPU 106, the AR/MR glasses 190, or other wired I/O devices 199 and other components that may require power when a power button has been actuated by a user. In an embodiment, the PMU 107 may monitor power levels and be electrically coupled to the information handling system operating as the AR/MR control computing device 100 to provide this power. The PMU 107 may be coupled to the bus 117 to provide or receive data or machine-readable code instructions. The PMU 107 may regulate power from a power source such as the battery 108 or AC power adapter 109. In an embodiment, the battery 108 may be charged via the AC power adapter 109 and provide power to the components of the information handling system operating as the AR/MR control computing device 100, via wired connections as applicable, or when AC power from the AC power adapter 109 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium 112 can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel® brand processor, AMD® brand processors, Qualcomm® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

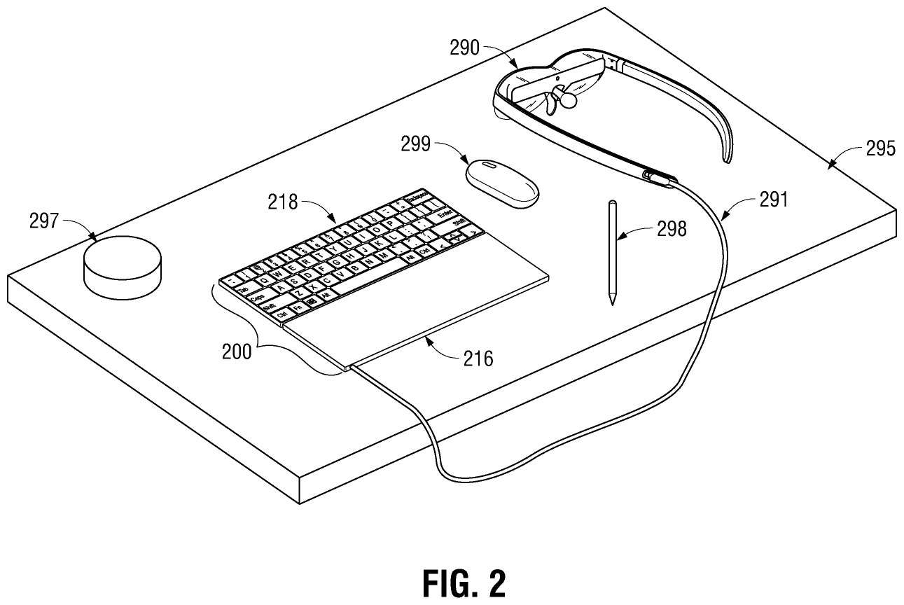

FIG. 2 is a graphical diagram illustrating a user workspace environment including the AR/MR control computing device information handling system operatively coupled to AR/MR glasses and a plurality of input/output (IO) devices for support of a mixed reality workspace ecosystem of hardware devices according to an embodiment of the present disclosure. The user workspace of the mixed reality workspace ecosystem with hardware devices includes an augmented reality/mixed reality (AR/MR) control computing device information handling system 200 housed within either or both of a combination keyboard 218 and touch drawing pad 216 and operatively coupled to AR/MR glasses 290 and a plurality of input/output (IO) devices 297, 298 and 299 on a desk in the user workspace according to an example embodiment. A user wearing augmented reality/mixed reality (AR/MR) glasses 290 in an embodiment may situate themselves in the user physical workspace that includes an AR/MR control computing device 200 incorporated within the keyboard 218 or the touch drawing pad 216 that may be combination device designed for operation with the AR/MR glasses 290 in the mixed reality workspace ecosystem with hardware devices. The AR/MR glasses 290 house projector electronic circuitry to project an intuitive virtual workspace topology surrounding the user for interaction with the intuitive virtual workspace topology using the physical workspace and I/O devices seamlessly in the mixed reality workspace ecosystem of embodiments of the present disclosure.

The user may choose a world view anchor, based on an initial position of the AR/MR glasses 290 that may serve as a reference point for the establishment of an intuitive virtual workspace topology surrounding the user as well as the hardware devices such as the keyboard 218, touch drawing pad 216, external accelerometer device 297, magnetic pen 298, or mouse 299 of the mixed reality workspace ecosystem with hardware devices. The established intuitive virtual workspace topology projected by the AR/MR glasses 290 includes multiple MR zones for various types of user interaction, including a keyboard zone, a virtual desktop display zone, and an environmental zone established initially based on the world view anchor as described embodiments herein. A camera in the AR/MR glasses 290 in an embodiment may capture one or more images of the surrounding structures, furniture, such as desk 295, keyboard 218, touch drawing pad 216, user's hands, and various operatively coupled input/output (IO) devices, such as mouse 299, magnetic pen 298, or an external accelerometer device 297 as viewed from the glasses view anchor at the initial position of the AR/MR glasses 290. An accelerometer within the keyboard 218 or touch drawing pad 216 or as standalone external accelerometer sensor 297 in various embodiment may detect and identify a user tapping on the desk 295 within a virtual desktop display zone as input in some embodiments.

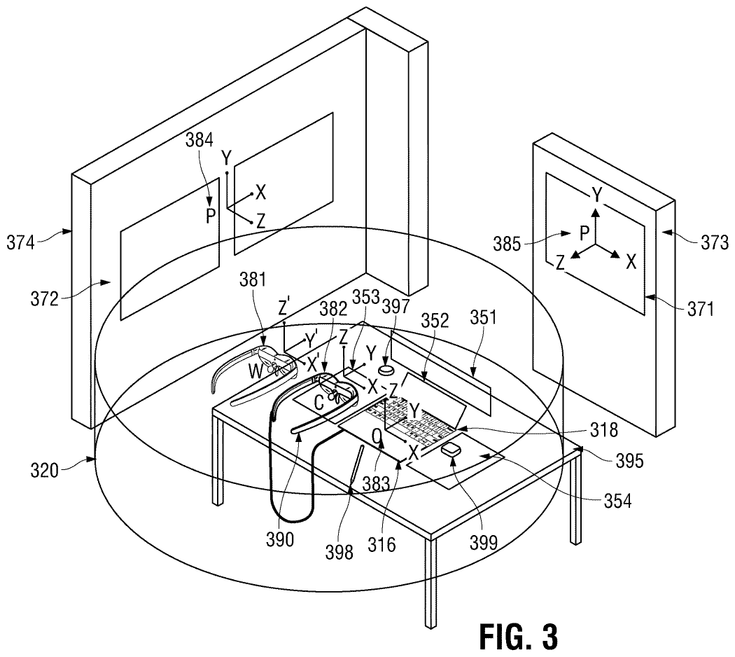

FIG. 3 is a graphical diagram illustrating a user workspace environment with an intuitive virtual workspace topology including a desktop zone, a keyboard zone, and an environmental zone forming a mixed reality workspace ecosystem with hardware devices including an AR/MR control computing device information handling system operatively coupled to AR/MR glasses according to an embodiment of the present disclosure. The intuitive virtual workspace topology and physical user workspace depicted in FIG. 3 comprise the mixed reality workspace ecosystem with hardware devices of embodiments herein.

Execution of the AR/MR workspace topology tracking and display orchestration system by an AR/MR control computing device information handling system operatively coupled to AR/MR glasses provides the mapped intuitive virtual workspace topology on the user's physical workspace to establish the mixed reality workspace ecosystem with hardware devices for user interaction in plural MR zones according to embodiments herein. The intuitive virtual workspace topology displayed by the AR/MR glasses 390 includes a virtual desktop display zone 320 presented as a cylindrical, elliptical, or elongated elliptical surface surrounding the user's head at eye-level as determined from the hardware processor of the AR/MR control computing device information handling system executing machine readable code instructions of the AR/MR workspace topology tracking and display orchestration system. The intuitive virtual workspace topology displayed with the AR/MR glasses 390 further includes a keyboard zone with one or more keyboard sub-zones 351, 352, 353, 354 surrounding the keyboard and other hardware devices and appearing in front of or closer to the user than the virtual desktop display zone 320. The intuitive virtual workspace topology displayed by the AR/MR glasses 390 also may include an environmental zone 371 or 372 displayed as fixed to and coplanar with one or more nearby static structures such as walls 373 or 374 respectively according to an embodiment of the present disclosure. As described herein, a user wearing augmented reality/mixed reality (AR/MR) glasses 390 in an embodiment may situate themselves in a user workspace that includes an AR/MR control computing device incorporated within a keyboard 318 or touch drawing pad 316 housing to generate or interact with the intuitive virtual workspace topology through the physical user workspace. This forms the seamless mixed reality workspace ecosystem with particular hardware devices and gesture detection for a user to interact with that defined intuitive virtual workspace topology therein. The user may choose a world view anchor 381, based on an initial position of the AR/MR glasses 390, that may serve as a reference point for the establishment of an intuitive virtual workspace topology surrounding the user, keyboard 318, and touch drawing pad 316, that includes multiple defined MR zones for various types of user interaction, including one or more keyboard zones 351, 352, 353, and 354, a virtual desktop display zone 320, and one or more environmental zones 384 and 385 which are defined for user input actions with gestures or specific I/O devices for manipulation between such MR zones in embodiments herein. These defined MR zones in the mixed reality workspace ecosystem with hardware devices provide for specific input actions between or within those MR zones with gesture inputs or specific I/O devices from the physical user workspace in embodiments herein.

Motion sensors, positional sensors, cameras, and other sensors within the AR/MR glasses 390 in an embodiment may begin tracking movement of the AR/MR glasses 390 with respect to the defined world view anchor 381 to provide a glasses view anchor 382 of the AR/MR glasses 390 having a position that varies over time with respect to the world view anchor 381. For example, the positional sensor of the operatively coupled AR/MR glasses 390 in an embodiment may comprise an accelerometer and orientation sensor providing positional telemetry that may include movement and orientation of the AR/MR glasses 390 over time with respect to a world view anchor 381 fixed to an initially recorded position of the AR/MR glasses 390 within the received positional telemetry (e.g., movement from 381 to 382) within the physical user workspace.

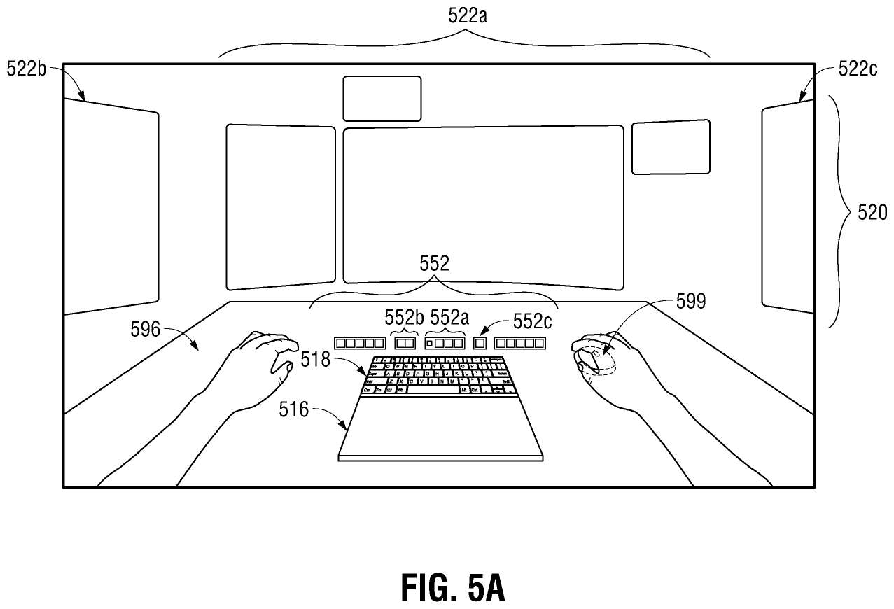

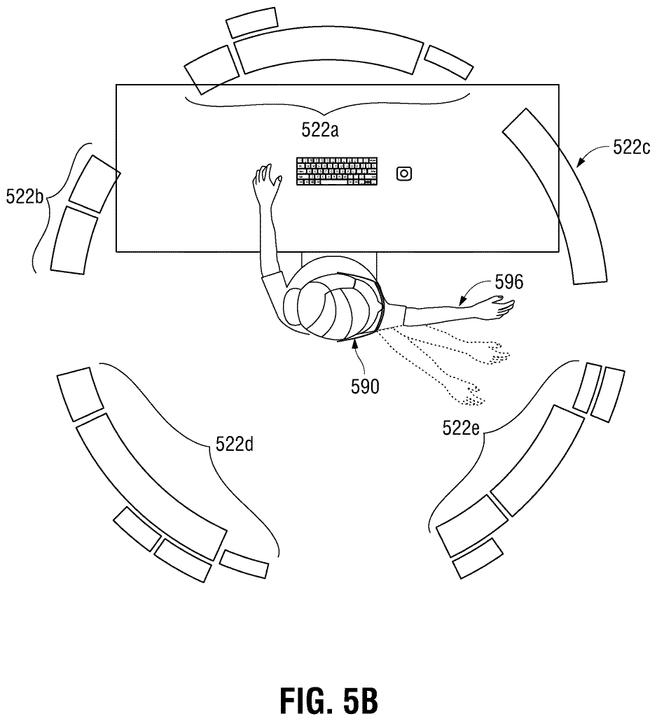

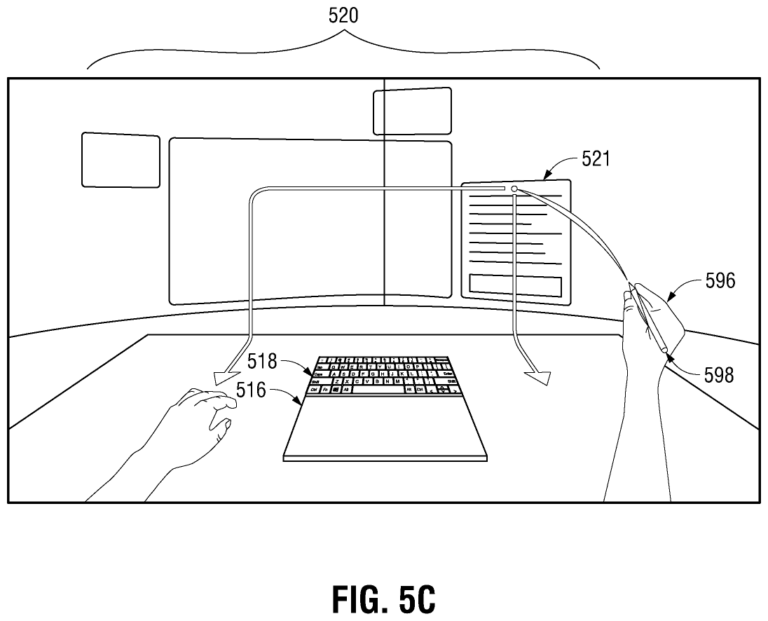

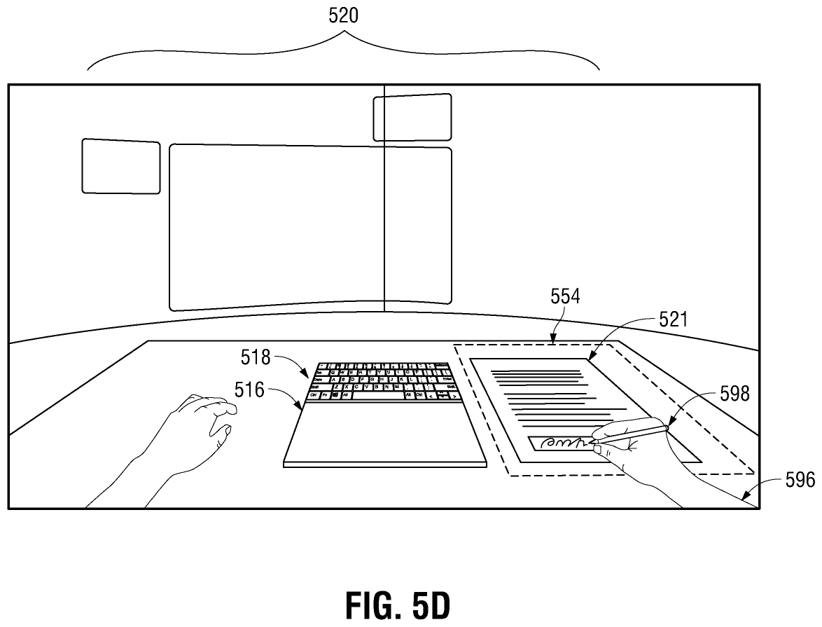

A camera in the AR/MR glasses 390 in an embodiment may capture one or more images of the surrounding structures such as walls 373 and 374, whiteboards or the like, furniture such as desk 395, keyboard 318, touch drawing pad 316, user's hands (not shown, but described below with respect to FIGS. 5A, 5B, 5C, and 5D), and various operatively coupled input/output (IO) devices, such as mouse 399, and magnetic pen 398, and external accelerometer device 399 as viewed from the glasses view anchor 382. Because the glasses view anchor 382 has a known position with respect to the world view anchor 381, based on the positional telemetry of the AR/MR glasses 390 received over time, positions or orientations of other anchors, structures, IO devices, or the user's hands with respect to the world view anchor 381 and the current glasses view anchor 382 may be determined based on the positions or orientations of other virtual anchors in the mapped mixed rea mixed reality workspace ecosystem with hardware devices.

Thus, interaction with the IO devices or detected gestures with the user's hands with respect to the glasses view anchor 382 may be received as input relative to locations of displayed software windows, widget icons, and the like among the MR zones mapped to form the mixed reality workspace ecosystem with hardware devices in various embodiments herein. A hardware processor of the AR/MR control computing device in an embodiment may execute machine readable code instructions of a position tracking module to identify static and unmoving surrounding structures 373 and 374, or furniture, such as a desk 395, as well as positions of these structures 373, 374, and 395 with respect to the glasses view anchor 382 and world view anchor 381, to create a virtual rendering of a world map of surrounding structures and furniture to generate the intuitive virtual workspace topology for the plural MR zones of the mapped mixed reality workspace ecosystem with hardware devices.

The hardware processor in an embodiment may determine whether a recently generated world map of the mixed reality workspace ecosystem with hardware devices matches a previously stored world map and may execute machine readable code instructions of the position tracking module to retrieve one or more previously identified and stored physical plane anchors 384 and 385 that each define a center point and orientation of a physical planar surface 374 and 373, respectively, with respect to the world view anchor 381. In such an embodiment, the hardware processor executing machine readable code instructions may retrieve the stored and previously modeled world map of the mixed reality workspace ecosystem with hardware devices for a user workspace including the physical plane anchors 384 and 385 fixed and oriented to the structural planar surfaces 374 and 373, respectively, modeling a plurality of environmental zones 372 and 371. These previously modeled environmental zones 372 and 371, respectively, are co-planar with the structural planar surfaces 374 and 373, and fixed to the physical plane anchors 384 and 385, respectively, based on the determined positions and orientations of the static structures 374 and 373, respectively, with respect to the world view anchor 381 with lower required computation for establishing new modeled environmental zones with image recognition software or other means. The hardware processor executing machine readable code instructions in an embodiment may determine the position and orientation of such physical planar surfaces 374 or 373 in an embodiment by comparing captured images to device reference images stored in a positional and gesture inference reference database to identify the static structure and orientation of the structure planar surfaces 373 and 374 with respect to the glasses view anchor 382.

In an embodiment in which the recently generated world map does not match a previously stored world map, the hardware processor of the AR/MR control computing device may execute machine readable code instructions of the position tracking module to identify, generate, and store one or more physical plane anchors 384 and 385 that each define a center point and orientation of a physical planar surface 374 or 373 detected by an onboard camera, respectively with respect to the world view anchor 381. The hardware processor executes machine readable code instructions of the position tracking module to build and generate these physical plane anchors 384 and 385 of the physical planar surfaces 373 or 374 from image recognition and ranging as additional elements in the intuitive virtual workspace topology of the mixed reality workspace ecosystem with hardware devices of embodiments herein.

Further, in embodiments herein the hardware processor in such an embodiment may also execute machine readable code instructions of the AR/MR workspace topology tracking and display orchestration system to identify the keyboard 318, the touch drawing pad 316, the static structures 373, and 374, or the desk 395 and other I/O devices within the plurality of captured images to model, as seen from a defined glasses view anchor 382 oriented and fixed to the AR/MR glasses 390 in updated glasses positional telemetry and having a determined position and orientation with respect to a world view anchor 381 for the keyboard zone and virtual desktop display zone as elements of the intuitive virtual workspace topology in mapping the mixed reality workspace ecosystem with hardware devices of embodiments herein. This may include establishing a modeled hardware anchor 383 relative to a hardware device, such as keyboard 318 or touch drawing pad 316 for the keyboard zones 351,352, 353, 354.

A hardware processor of the AR/MR control computing device in an embodiment may execute machine readable code instructions of an AR/MR workspace topology tracking and display orchestration system to compare captured images to device reference images stored in a positional and gesture inference reference database to identify the keyboard 318, the touch drawing pad 316, and any other operatively coupled IO devices, such as mouse 399, or magnetic pen 398, as well as distances, angles, and orientations of these devices 316, 318, 398 or 399 with respect to the glasses view anchor 382 and world view anchor 381. In an embodiment, the hardware processor of the AR/MR control computing device may execute machine readable code instructions of the device tracking module to identify one or more hardware device anchors 383 that each define a center point and orientation of an identified IO device, such as combined keyboard 318 and touch drawing pad 316 with respect to the world view anchor 381 or glasses view anchor 382. This may be achieved through the hardware processor executing machine readable code instructions to compare the plurality of captured images to device reference images stored in a positional and gesture inference reference database to identify the keyboard 318, touch drawing pad 316 and a keyboard 318 or touch drawing pad 318 orientation of the keyboard planar surface (e.g., planar surface of desk 395) with respect to the glasses view anchor 382 or may be generated and modeled from image recognition of images captured by the camera on the AR/MR glasses 390.

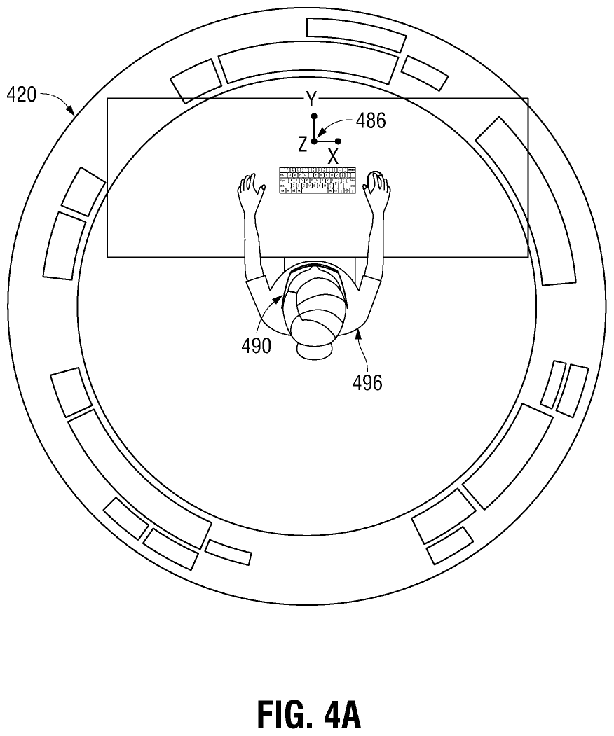

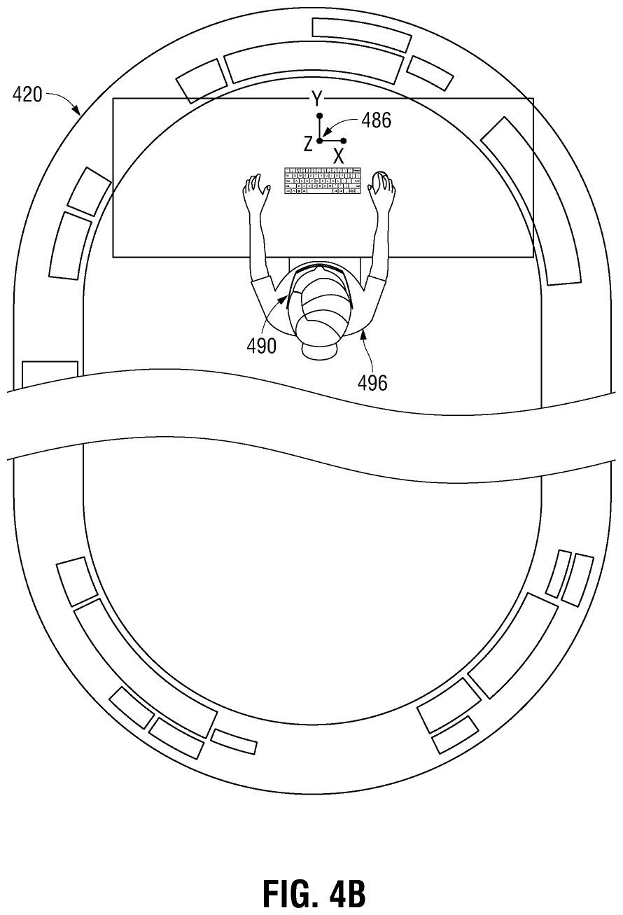

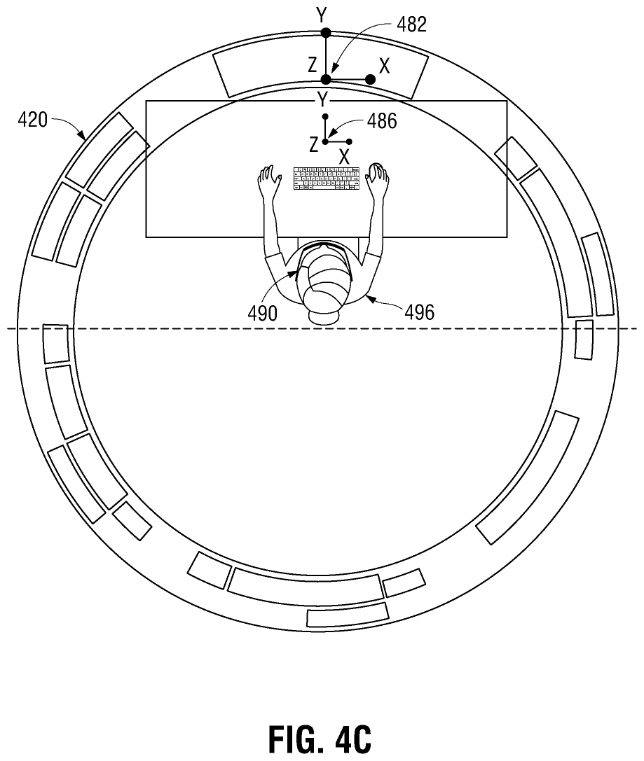

In additional embodiments, a position of the virtual desktop display zone 320 may be modeled and generated relative to the glasses view anchor 382 and world view anchor 381 and may be formed relative to selection of a cylindrical, elliptical, elongated elliptical, stadium or other surface shape for the virtual desktop display zone 320 from settings of the AR/MR workspace topology tracking and display orchestration system that may be selected by a user from a control graphical user interface displayed via the AR/MR glasses 390. In an embodiment, the hardware processor of the AR/MR control computing device may execute machine readable code instructions of the AR/MR workspace topology tracking and display orchestration system to model the virtual cylindrical, elliptical, elongated elliptical or other shaped software application window display surface surrounding the user having a virtual desktop display zone anchor (not shown, but described below with respect to FIGS. 4A, 4B, and 4C) at a defined distance and orientation with respect to the glasses view anchor 381, depending on previously provided user preferences for virtual desktop display zone distance and elliptical shape from the user. This location may also be referenced to the hardware device anchor 383 and a keyboard zone location in some embodiments.

The hardware processor executing machine readable code instructions of the AR/MR workspace topology tracking and display orchestration system in an embodiment may model an environmental zone 371 or 372 that is co-planar with the structural planar surfaces 374 and 373, respectively and fixed to the physical plane anchors 384 and 385, respectively, one or more keyboard zones 351, 352, 353, and 354 that are co-planar with the keyboard planar surface (e.g., with the desk 395) and fixed to the hardware device anchor 383, and a desktop zone 320 within a modeled surface at least partially surrounding the user that is fixed to the virtual desktop display zone anchor. The hardware processor of the AR/MR control computing device may execute machine readable code instructions of a digital images graphics generation module to generate digital images for display via the AR/MR glasses 390 within a virtual desktop display zone 320 centered upon and oriented by the virtual desktop display zone anchor, within one or more virtual keyboard zones 351, 352, 353, or 354 centered upon and oriented by one of the hardware device anchors 383, and within one or more virtual environmental zones 372 or 371 centered upon and oriented by one or more of the physical plane anchors 384 or 385, respectively. The hardware processor of the AR/MR control computing device in an embodiment may then execute machine readable code instructions of an augmented projected images transformation module to adjust the shape, size, position, or viewing angle of the generated digital images and to instruct the AR/MR glasses 390 to display them within the modeled virtual desktop display zone 320, one or more virtual keyboard zones 351, 352, 353, or 354, or one or more virtual environmental zones 372 or 371, based on positions of the virtual desktop display zone anchor, one or more hardware device anchors 383, or one or more physical plane anchors 384 or 385, respectively, with respect to the world view anchor 381 and glasses view anchor 382.

As described herein, the user in an embodiment may interact with digital images displayed within the one or more environmental zones 372 or 371, the one or more keyboard zones 351, 352, 353, or 354, or the virtual desktop display zone 320, via one or more operatively coupled input/output (IO) devices, such as a mouse 399 or magnetic pen 398, for example, or through recognized user gesture or tapping on the desk 395 supporting the keyboard 318 or touch drawing pad 316. Magnetic pen sensors within the keyboard 318 or the touch drawing pad 316 in an embodiment may identify movement and position of the magnetic pen 398 with respect to one or more hardware device anchors 383 defining the one or more virtual keyboard zones 351, 352, 353, or 354. An accelerometer within the keyboard 318 or touch drawing pad 316 or as standalone sensor 397 in an embodiment may identify a user tapping on the desk 395 within a virtual desktop display zone 354.

FIG. 4A is a graphical diagram illustrating a top view of a mixed reality workspace ecosystem of hardware devices with a cylindrical virtual desktop display zone fixed to and centered upon a glasses view anchor of the AR/MR glasses for the display of software application windows according to an embodiment of the present disclosure. The hardware processor of the AR/MR control computing device executes machine readable code instructions of an AR/MR workspace topology tracking and display orchestration system to generate a cylindrical virtual desktop display zone that is fixed to and centered upon a glasses view anchor of augmented reality/mixed reality (AR/MR) glasses for the display of software application windows for software applications executing within the operating system of the AR/MR control computing device according to an embodiment of the present disclosure. As described herein, the hardware processor of the AR/MR control computing device may execute machine readable code instructions of the position tracking module models a virtual cylindrical surface surrounding the user 496 having a virtual desktop display zone anchor 486 at a defined distance and orientation with respect to the glasses view anchor (here shown as having the same position and orientation as the virtual desktop display zone anchor 486). The hardware processor of the position tracking module may operate to maintain positioning of the AR/MR glasses relative to the generated cylindrical virtual desktop display zone 420 as a user 496 turns her head to view various software application windows being displayed by an augmented projected images transformation module to fit in around the cylindrical surface in embodiments herein.

The user may select previously provided user preferences for virtual desktop display zone distance and elliptical shape from the user. For example, it is contemplated that the user may select the projected elliptical surface shape from a cylindrical shaped surface, an extended ellipse shaped surface, a stadium shaped surface (e.g., a rectangle with semi-circular ends) or others around a user's position in an virtual desktop display zone 420 of the intuitive virtual workspace topology of embodiments herein. Further, the viewable projected elliptical surface, as viewable from the AR/MR glasses 490, may surround the user's position partially or fully. The user may select among elliptical shapes of the modeled elliptical surface of the virtual desktop display zone 420 via user input received from the user at a control graphical user interface displayed via the AR/MR glasses 490. In another example embodiment, the user 496 in an embodiment described with respect to FIG. 4A may have previously selected, via a control graphical user interface, to lock the position and orientation of the virtual desktop display zone anchor 486 in the same position and orientation of the glasses view anchor, such that the virtual elliptical surface forming the virtual desktop display zone 420 is cylindrical (e.g., an ellipse having an eccentricity of zero) or semi-circular at the ends (e.g., a stadium shape) and centered on the virtual desktop display zone anchor 486 for movements of the glasses view anchor relative thereto. The hardware processor of the AR/MR control computing device in such an embodiment may execute machine readable code instructions of a digital images graphics generation module to generate digital images for display via the AR/MR glasses 490 an modify the projected images with the augmented projected images transformation module to shape and adjust software application windows to fit and curve within the cylindrical virtual desktop display zone 420 centered upon and oriented by the virtual desktop display zone anchor 486.

FIG. 4B is a graphical diagram illustrating a top view of a mixed reality workspace ecosystem of hardware devices with a user-selected elliptical virtual desktop display zone having a virtual desktop display zone anchor set at a user-specified distance from a glasses view anchor of AR/MR glasses for the display of software application windows according to an embodiment of the present disclosure. The hardware processor of the AR/MR control computing device executes machine readable code instructions of an AR/MR workspace topology tracking and display orchestration system to generate the elliptical virtual desktop display zone 420 fixed and centered on a virtual desktop display zone anchor set at a user-specified distance from a glasses view anchor 486 of the AR/MR glasses 490 according to an embodiment of the present disclosure. In another example embodiment, the user 496 described with respect to FIG. 4B may have previously selected to lock the position and orientation of the virtual desktop display zone anchor 486 in the same position and orientation of the glasses view anchor, and to form an elliptical surface for the elliptical virtual desktop display zone 420, centered on the virtual desktop display zone anchor 486 that may be the world view anchor and relative to the glasses view anchor of the AR/MR glasses 490. The hardware processor of the AR/MR control computing device in such an embodiment may execute machine readable code instructions of a digital images graphics generation module to generate digital images for display via the AR/MR glasses 490 within the elliptical virtual desktop display zone 420 centered upon and oriented by the virtual desktop display zone anchor 486, but having a more elongated shape than the circular shape described with respect to FIG. 4A, above. The hardware processor of the position tracking module may operate to maintain positioning of the AR/MR glasses relative to the generated elliptical virtual desktop display zone 420 as a user 496 turns her head to view various software application windows being displayed by an augmented projected images transformation module to fit in around the elliptical surface in embodiments herein. Again, it is contemplated that the projected elliptical surface may include a cylindrical shaped surface, an extended ellipse shaped surface, a stadium shaped surface (e.g., a rectangle with semi-circular ends) or others around a user's position in an virtual desktop display zone of the intuitive virtual workspace topology of embodiments herein. Further, the viewable projected elliptical surface of the virtual desktop display zone 420, as viewable from the AR/MR glasses 490, may surround the user's position partially or fully.

FIG. 4C is a graphical diagram illustrating a top view of mixed reality workspace ecosystem of hardware devices with a user-selected cylindrical virtual desktop display zone having a virtual desktop display zone anchor set at a user-specified distance from a glasses view anchor of AR/MR glasses for the display of software application windows according to an embodiment of the present disclosure. The hardware processor of the AR/MR control computing device executes machine readable code instructions of an AR/MR workspace topology tracking and display orchestration system to generate the user selected cylindrical virtual desktop display zone 420 that has a virtual desktop display zone anchor 482 set at a user-specified distance for the AR/MR glasses that is closer at the front of the user selected cylindrical virtual desktop display zone 420 for a closer view than the cylindrical virtual desktop display zone shown in FIG. 4A according to an embodiment of the present disclosure. In yet another example embodiment, the user 496 described with respect to FIG. 4C may have previously selected to fix the virtual desktop display zone anchor 486 at the user selected closer preset distance for the glasses view anchor 496 that provides a comfortable viewing distance for the user 496 closer to a front workspace of the user selected cylindrical virtual desktop display zone 420 but further from displayed software application windows behind the AR/MR glasses that are not actively being used. The hardware processor of the AR/MR control computing device in such an embodiment may execute machine readable code instructions of a digital images graphics generation module to generate digital images for display via the AR/MR glasses 490 within the user-selected cylindrical virtual desktop display zone 420 centered upon and oriented by the virtual desktop display zone anchor 486 situated at an adjusted preset distance that is closer from the virtual desktop display zone anchor 486 for the AR/MR glasses that provides a comfortable, closer selected viewing distance for the user 496 while the back of the cylindrical surface is further from the virtual desktop display zone anchor 486. The hardware processor of the position tracking module may operate to maintain positioning of the AR/MR glasses relative to the generated user selected cylindrical virtual desktop display zone 420 as a user 496 turns her head to view various software application windows being displayed by an augmented projected images transformation module to fit in around the user selected cylindrical surface at the user selected adjusted distances from around that cylindrical surface in embodiments herein.

FIG. 5A is a graphical diagram illustrating a mixed reality workspace ecosystem of hardware devices with a virtual desktop display zone and a keyboard zone as projected and viewed from AR/MR glasses for the display of software application windows and interactive widget icons in an intuitive virtual workspace topology according to an embodiment of the present disclosure. The virtual desktop display zone 520 and the keyboard zone 552 both incorporate projected digital images relating to software application windows executing at an operating system of the augmented reality/mixed reality (AR/MR) control computing device, as projected via AR/MR glasses according to an embodiment of the present disclosure. As described herein, a camera in the AR/MR glasses in an embodiment may capture one or more images of the surrounding structures, furniture, keyboard 518, touch drawing pad 516, user's hands 596, and various operatively coupled input/output (IO) devices 599, as viewed from the glasses view anchor. The hardware processor of the AR/MR control computing device may execute machine readable code instructions of a digital images graphics generation module to generate digital images for display via the AR/MR glasses of software application windows within a virtual desktop display zone 520 including software application window sub-workspaces 522a, 522b, and 522c, and to display virtual widget icon sets 552a, 552b, or 552c within a virtual keyboard zone 552 centered upon and oriented by one of the hardware device anchors (e.g., device anchor 383 of FIG. 3 fixed to the position of keyboard 318). The hardware processor of the AR/MR control computing device in an embodiment may also execute machine readable code instructions of an augmented projected images transformation module to adjust the shape, size, position, or viewing angle of the generated digital images and to instruct the AR/MR glasses to display software application windows in an organized orientation within the modeled virtual desktop display zone 520 including within software application window sub-workspaces 522a, 522b, and 522c, and to display virtual widget icon sets 552a, 552b, or 552c in virtual keyboard zone 552, based on positions of the virtual desktop display zone anchor, and one or device anchors, respectively.

A user in an embodiment may interact with these two-dimensional generated images representing software application windows projected onto a modeled elliptical virtual desktop display zone 520 that includes software application window sub-workspaces 522a, 522b, and 522c, via AR/MR glasses, and using IO devices 599 operatively coupled to the AR/MR control computing device. In an embodiment, the user may use one or more operatively coupled IO devices 599 to group software application windows into virtual desktop software application window sub-workspaces, such as 522a, 522b, or 522c, each oriented at a different position within the elliptical virtual desktop display zone. For example, virtual desktop sub-workspace 522a may be selected by the user for display within a front-facing portion of the elliptical virtual desktop display zone 520, which may be situated directly in front of the user and the AR/MR glasses. The hardware processor of the AR/MR control computing device in an embodiment may also execute machine readable code instructions of the digital images graphics generation module to generate one or more taskbar digital images of virtual widget icon sets 552a, 552b, or 552c for display via the AR/MR glasses within a taskbar of the virtual keyboard zone 552, where the taskbar digital images of virtual widget icon sets 552a, 552b, or 552c each represent or link to one of the software application window desktop sub-workspaces 522a, 522b, or 522c, respectively. In an embodiment, the hardware processor of the AR/MR control computing device may execute machine readable code instructions of the augmented projected images transformation module to adjust the shape, size, position, or viewing angle of the generated taskbar digital images of virtual widget icon sets 552a, 552b, or 552c, and to display them within the taskbar of the virtual keyboard zone 552.

The AR/MR glasses camera in an embodiment may capture images of the user hands 596 as they interact with physical IO devices 599 or images projected within one or more of the environmental zone, keyboard zone 552, or desktop zone that includes 522a, 522b, and 522c, via the AR/MR glasses. In an embodiment, the hardware processor of the AR/MR control computing device may also execute machine readable code instructions of the user gesture detection module, or magnetic pen firmware to associate an identified user command gesture, magnetic pen usage, or user tap with a command instruction for interaction with a software application window, widget, virtual IO device, or ornamental image represented by a projected image displayed within the virtual desktop display zone 520 that includes 522a, 522b, and 522c, the virtual keyboard zone 552, or the virtual environmental zone. For example, the hardware processor of the AR/MR control computing device may execute machine readable code instructions of the user gesture detection module to associate an identified user command gesture tapping one of the taskbar digital image virtual widget icon sets 552a with a command to place the software application window desktop sub-workspace 522a associated with the taskbar digital image virtual widget icon set 552a for display within a front-facing portion of the elliptical virtual desktop display zone, which may be situated directly in front of the user and the AR/MR glasses.

FIG. 5B is a graphical diagram illustrating a top view of a mixed reality workspace ecosystem of hardware devices with user gesturing to adjust the display of various software application window sub-workspaces of a virtual desktop display zone in an intuitive virtual workspace topology according to an embodiment of the present disclosure. The user's gestures adjust the display of various virtual desktop display zone software application window sub-workspaces 522a, 522b, 522c, 522d, and 522e oriented in a pattern surrounding the user according to an embodiment of the present disclosure. In an embodiment, a camera in the AR/MR glasses 590 may capture one or more images of the user's hands 596 as the user performs a swiping motion to shift positions of the various software application window desktop sub-workspaces 522a, 522b, 522c, 522d, and 522e, as viewed in a virtual desktop display zone at eye level with the user from the glasses view anchor of AR/MR glasses 590 on a user. In an example embodiment, the hardware processor of the AR/MR control computing device may recognize such a gesture by executing machine readable code instructions of a user gesture detection module, to compare captured images of the user hands 596 against stored gesture inference images in the positional and gesture inference reference database to identify a user command gesture, based on identification of pose, position, or movement of a user's hand 596 within the plurality of captured images.

In an embodiment, the hardware processor of the AR/MR control computing device may execute machine readable code instructions of the user gesture detection module to associate the identified user command gesture to shift positions of the various software application window desktop sub-workspaces 522a, 522b, 522c, 522d, and 522e, with a command instruction for such a movement of the displayed images of the various software application window desktop sub-workspaces 522a, 522b, 522c, 522d, and 522e. The hardware processor of the AR/MR control computing device may execute machine readable code instructions of the augmented projected images transformation module to readjust the shape, size, position, or viewing angle of a plurality of projected and generated digital images representing software application window desktop sub-workspaces 522a, 522b, 522c, 522d, and 522e with respect to the virtual desktop display zone anchor upon receipt of the identified user command to scroll between the software application window desktop sub-workspaces 522a, 522b, 522c, 522d, and 522e.

FIG. 5C is a graphical diagram illustrating an AR/MR glasses view of mixed reality workspace ecosystem of hardware devices with a user providing user input to move the display of a software application window from a virtual desktop display zone to a keyboard zone in an intuitive virtual workspace topology according to an embodiment of the present disclosure. A user 596, through augmented reality/mixed reality (AR/MR) glasses, provides user input to the AR/MR control computing device information handling system to move the display of a software application window 521 from a software application window desktop sub-workspace of a virtual desktop display zone 520 to a keyboard zone location according to an embodiment of the present disclosure. A camera in the AR/MR glasses in an embodiment may capture one or more images of the user's hands 596, and various operatively coupled input/output (IO) devices, such as magnetic pen 598, as viewed from the glasses view anchor, as they interact with two-dimensional generated images of software application windows 521 projected onto a modeled elliptical virtual desktop display zone 520.

A hardware processor of the AR/MR control computing device may execute machine readable code instructions of a user gesture detection module, to compare captured images of user hands 596 against stored gesture inference images in the positional and gesture inference reference database to identify a user command gesture, such as dragging and dropping the two-dimensional generated image of a software application window 521 from the virtual desktop display zone 520 to a keyboard zone (not shown, but described in greater detail below with respect to FIG. 5D). In an embodiment, the hardware processor of the AR/MR control computing device may execute machine readable code instructions of the user gesture detection module, or magnetic pen firmware to associate an identified user command gesture, or magnetic pen 598 usage with a command instruction for interaction with a projected image of the software application window 521 displayed within the virtual desktop display zone 520, such as dragging and dropping the two-dimensional generated image of the software application window 521 from the virtual desktop display zone 520 to a keyboard zone (not shown, but described in greater detail below with respect to FIG. 5D). In such an embodiment, the hardware processor may execute machine readable code instructions to readjust the software application window image 521 shape, size, position or viewing angle for the software application window, based on position and orientation of the hardware device anchor in the keyboard zone with respect to the glasses view anchor, for display within the keyboard zone.

FIG. 5D is a graphical diagram illustrating the AR/MR glasses view of mixed reality workspace ecosystem of hardware devices with the display of the software application window moved from the virtual desktop display zone to the keyboard zone in the intuitive virtual workspace topology according to an embodiment of the present disclosure. The software application window 521 has been moved from a virtual desktop display zone 520 to a keyboard zone 554, pursuant to a received user input to the augmented reality/mixed reality (AR/MR) control computing device operating in keyboard 518 or touch drawing pad 516 according to an embodiment of the present disclosure. The hardware processor of the AR/MR control computing device in an embodiment may execute machine readable code instructions of a user gesture detection module, to compare captured images of user hands 596 against stored gesture inference images in the positional and gesture inference reference database to identify a user command gesture, such as dragging and dropping the two-dimensional generated image of a software application window 521 from the virtual desktop display zone 520 to a keyboard zone 554. In an embodiment, the hardware processor of the AR/MR control computing device may execute machine readable code instructions of the user gesture detection module, or magnetic pen firmware to associate an identified user command gesture, or magnetic pen 598 usage with a command instruction for interaction with a software application window represented by a projected image of the software application window 521, such as dragging and dropping the two-dimensional generated image of the software application window 521 from the virtual desktop display zone 520 to a keyboard zone 554. In such an embodiment, the hardware processor may execute machine readable code instructions to readjust an application window image 521 shape, size, position or viewing angle for the software application window, based on position and orientation of the hardware device anchor with respect to the glasses view anchor, for display within the keyboard zone 554 for interaction by a user in the keyboard zone 554.

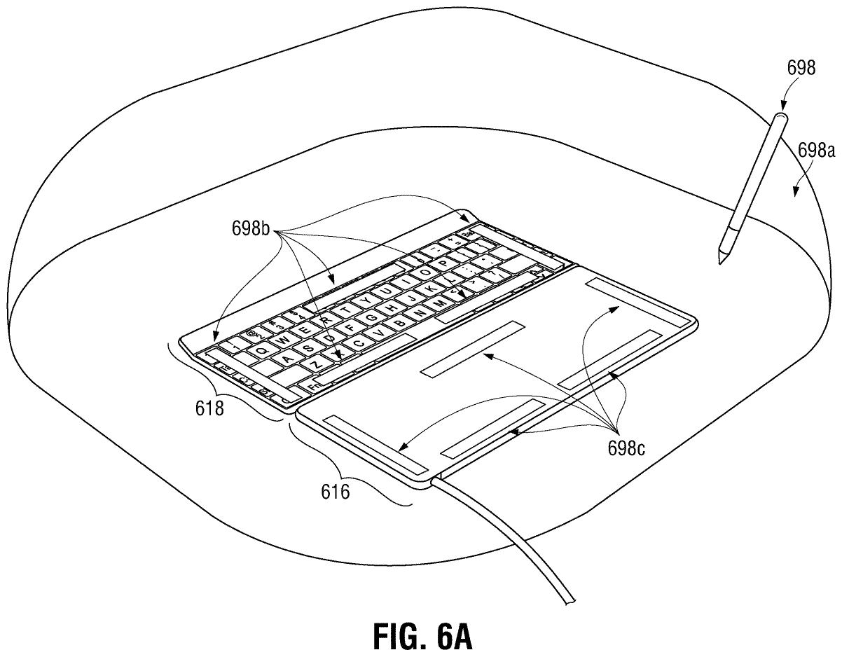

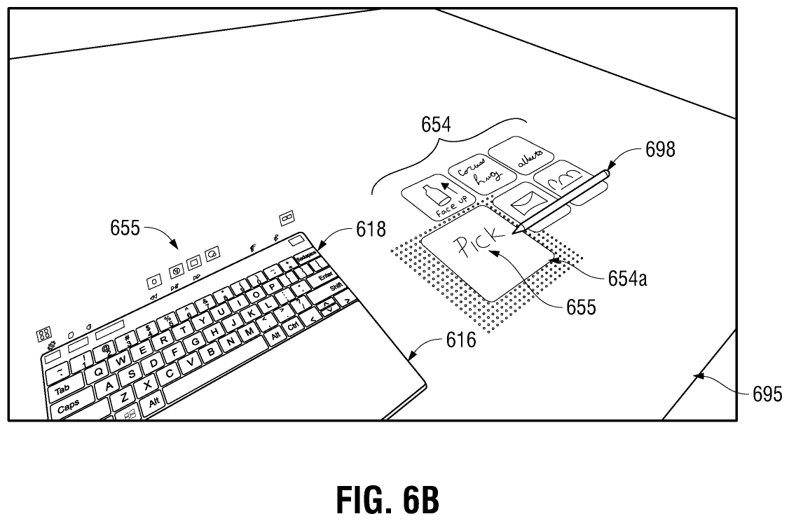

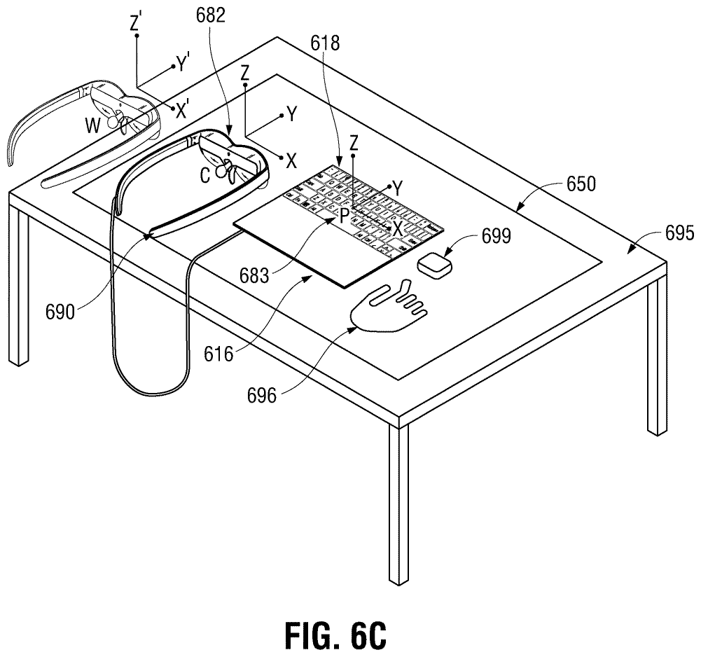

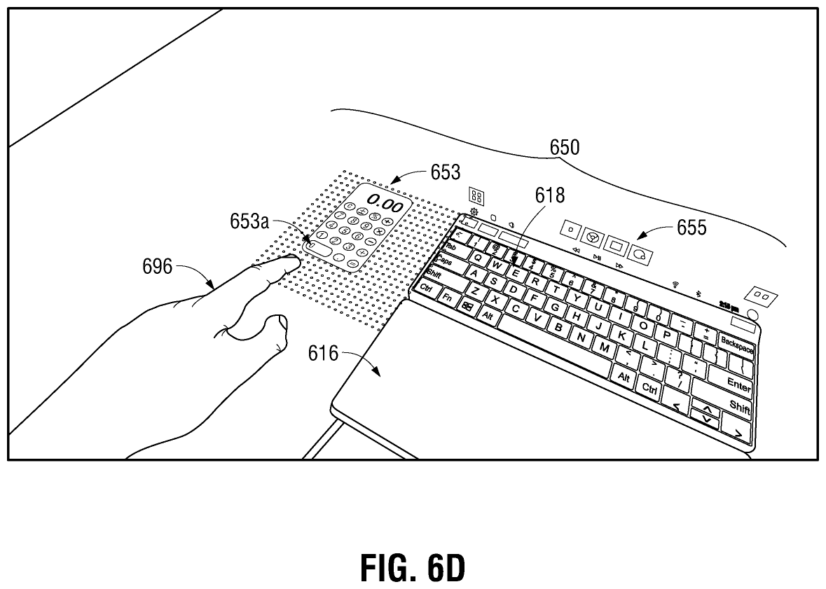

FIG. 6A is a graphical diagram illustrating plural magnetic pen sensors in a keyboard or a touch drawing pad detecting movement of a magnetic pen input/output (IO) device in a keyboard zone of an intuitive virtual workspace topology of a mixed reality workspace ecosystem of hardware devices according to an embodiment of the present disclosure. One or more magnetic pen sensors 698a or 698b are incorporated within a housing for a keyboard 618 or a touch drawing pad 616 for detecting movement of a magnetic pen input/output (IO) device 698 with respect to the keyboard 618 or touch drawing pad 616 according to embodiments herein.

Magnetic pen sensors 698b or 698c within the keyboard 618 or the touch drawing pad 616, respectively, in an embodiment may identify movement and position of the magnetic pen 698 with respect to one or more hardware device anchors fixed to the keyboard 618, touch drawing pad 616, or both, wherein the hardware device anchors defining the virtual keyboard zone.

Magnetic field strength from the magnetic pen 698 may be detected by the known arrangement of the magnetic pen sensors 698b or 698c within the keyboard 618 or the touch drawing pad 616 such that differences across the different magnetic pen sensors 698b or 698c may be used to identify a location of a magnetic pen 698 in a keyboard zone. The detected differences of magnetic field strength detected from the spaced magnetic pen sensors 698b or 698c may be used to detect magnetic pen 698 location or movement in the keyboard zone, for example, relative to the hardware device anchor position and direction of the keyboard 618 or the touch drawing pad 616 in embodiments herein. The magnetic pen sensors 698b or 698c have a limited range 698a of effectiveness magnetic field sensing from magnetic pen 698 that covers the keyboard zone in embodiments herein.

FIG. 6B is a graphical diagram illustrating display of a magnetic pen ink image having a pattern following received movement of a magnetic pen IO device within a keyboard zone in an intuitive virtual workspace topology of a mixed reality workspace ecosystem of hardware devices according to an embodiment of the present disclosure. The display of a magnetic pen ink image 655 depicts a drawn pattern following received movement of a magnetic pen 698, via augmented reality/mixed reality (AR/MR) glasses (not shown) and within a keyboard zone 654 as detected by magnetic pen sensors according embodiments described in the present disclosure. In an embodiment, the hardware processor of the AR/MR control computing device may execute machine readable code instructions of the magnetic pen firmware to associate an identified magnetic pen 698 movement or usage, such as detected by the plurality of spaced magnetic pen sensors in a keyboard zone 654, with a command instruction for interaction with a software application window, virtual widget icon, virtual IO device, or virtual writing surface, such as a virtual window, document, or note of virtual writing surface 654a, represented by a projected image and displayed within the virtual keyboard zone 654. The displayed virtual window, document, or note of virtual writing surface 654a within the keyboard zone 654 is anchored to a hardware device anchor fixed to the keyboard 618, the touch drawing pad 616, or both on the desk 695 in the user's physical workspace.

The hardware processor of the AR/MR control computing device may execute machine readable code instructions of the digital images graphics generation module to generate a virtual inked digital image 655, such as the written word “Pick,” for display via the AR/MR glasses within the virtual window, document, or note of virtual writing surface 654a projected on the virtual desktop display zone 654 by the AR/MR glasses, to represent magnetic pen drawing detected by movement of the magnetic pen 698. The hardware processor may then execute machine readable code instructions to adjust the shape, size, position or viewing angle of the generated magnetic pen ink image 655, such as the written word “Pick,” having a pattern following the received movement of the magnetic pen 698 on the virtual window, document, or note of virtual writing surface 654a in the keyboard zone 654. This adjustment to the generated magnetic pen ink image 655 is based on the position and orientation of the hardware device anchor fixed to the keyboard 618, the touch drawing pad 616, or both and with respect to the glasses view anchor, for display via the AR/MR glasses within the keyboard zone 654 and on the virtual window, document, or note of virtual writing surface 654a.

Additionally, FIG. 6B depicts virtual widget icons 655 displayed by execution of software applications, such as an OS for function keys or an AR/MR workspace topology tracking and display system for controls of a virtual workspace, in another portion of the keyboard zone located at the front or along the top of the keyboard 618 according to an embodiment. The virtual widget icons 655 are displayed by the AR/MR glasses on the virtual desktop display zone 650 and also tied to the hardware device anchor for the keyboard 618, touch drawing pad 616, or both and with respect to the glasses view anchor of the AR/MR glasses present location. With these reference points, the virtual widget icons 655 are displayed by the AR/MR glasses within the keyboard zone along the top of keyboard 618 and are tied to the keyboard 618 within the virtual workspace in an embodiment.

FIG. 6C is a graphical diagram illustrating a perspective view of a user workspace for a mixed reality workspace ecosystem of hardware devices with detected tapping of a user on a desk, via an accelerometer, to provide user input to a software application window in an intuitive virtual workspace topology according to an embodiment of the present disclosure. The user 696 in a user workspace may tap on a desk 695 and vibrations detected, via an accelerometer, to provide user input to a software application having a software application window displayed via the augmented reality/mixed reality (AR/MR) glasses 690 according to an embodiment of the present disclosure. An accelerometer within the keyboard 618, touch drawing pad 616, or an external accelerometer device 699 in an embodiment may identify a user 696 tapping on the desk 695 within a virtual desktop display zone 654 anchored by a hardware device anchor 683 fixed to the keyboard 618, the touch drawing pad 616, or both on the desk 695 in the user's physical workspace. The hardware processor executing machine readable code instructions may generate and adjust an updated image shape, size, position or viewing angle of updated digital image of a software application window, based on the received user input of tapping the desk 695 in the user workspace and position and orientation of the hardware device anchor with respect to the glasses view anchor of the AR/MR glasses 690. The accelerometer detector within the keyboard 618, touch drawing pad 616, or an external accelerometer device 699 in various embodiments may detect vibration from the desk 695 as an input to some aspect of the software applications generating digital images such as a software application window displayed within a virtual desktop display zone or a keyboard zone 650. This adjustment to the updated digital image of the software application window is displayed via the AR/MR glasses within the virtual desktop display zone or the keyboard zone 650.

The hardware processor executing machine readable code instructions may identify a user command to one of the plurality of software application windows displayed within the virtual desktop display zone or the keyboard zone 650, based at least partially on such a received notification of a user 696 tap from an accelerometer of the keyboard 618, touch drawing pad 616, or external accelerometer device 699. A hardware processor of the AR/MR control computing device in an embodiment may execute machine readable code instructions of the software application having a software application window displayed within the virtual desktop display zone or keyboard zone 650 to execute the identified user command instruction associated with the user 696 tap on the desk 695. The hardware processor executing machine readable code instructions may then generate and adjust an updated image shape, size, position or viewing angle of an updated digital image of the software application window reflecting processing of the identified user command instruction by the software application, based on the position and orientation of the hardware device anchor 683 with respect to the glasses view anchor 682, for display via the AR/MR glasses within the virtual desktop display zone or the keyboard zone 650.

FIG. 6D is a graphical diagram illustrating an AR/MR glasses view of a display of a virtual input/output device in a keyboard zone receiving user input in the form of a detected hand gesture or user tapping user input to a software application window in an intuitive virtual workspace topology according to an embodiment of the present disclosure. The virtual I/O device widget 653 displayed with AR/MR glasses serves as a software application window receiving user input in the form of a detected hand gesture or user tapping detected from camera images captured of user's hand 696 according to an embodiment of the present disclosure. A hardware processor of the AR/MR control computing device in an embodiment capture images of a user's hand 696 with a camera onboard the AR/MR glasses and execute machine readable code instructions of a user gesture detection module, to compare captured images of user hands 696 against stored gesture inference images in the positional and gesture inference reference database to identify a user command gesture, such as the user pressing a virtual button 653a within a projected image of a virtual I/O device widget 653 for a software application window, such as a calculator application. The hardware processor of the AR/MR control computing device may execute machine readable code instructions of the user gesture detection module to associate such an identified user command gesture from captured images, along with a user tap identified by an accelerometer in some embodiments, with a command instruction for interaction with the calculator application represented by the software application window of the virtual I/O device widget 653. The hardware processor of the AR/MR control computing device in an embodiment may execute machine readable code instructions of the calculator software application having a software application window of the virtual I/O device widget 653 displayed within keyboard zone 650 to execute the identified command instruction associated with the identified user gesture or user tap on the desk.

The software application window of the virtual I/O device widget 653 is displayed by the AR/MR glasses on the virtual desktop display zone 650 and tied to the hardware device anchor for the keyboard 618, touch drawing pad 616, or both and with respect to the glasses view anchor of the AR/MR glasses present location. With these reference points, the software application window of the virtual I/O device widget 653 is displayed by the AR/MR glasses within keyboard zone 650 and tied to the keyboard 618, touch drawing pad 616, or both.

Additionally, FIG. 6D depicts virtual widget icons 655 displayed by execution of software applications, such as an OS for function keys or an AR/MR workspace topology tracking and display system for controls of a virtual workspace, in a keyboard zone 650. The virtual widget icons 655 are displayed by the AR/MR glasses on the virtual desktop display zone 650 and also tied to the hardware device anchor for the keyboard 618, touch drawing pad 616, or both and with respect to the glasses view anchor of the AR/MR glasses present location. With these reference points, the virtual widget icons 655 are displayed by the AR/MR glasses within keyboard zone 650 and tied to the keyboard 618, touch drawing pad 616, or both.

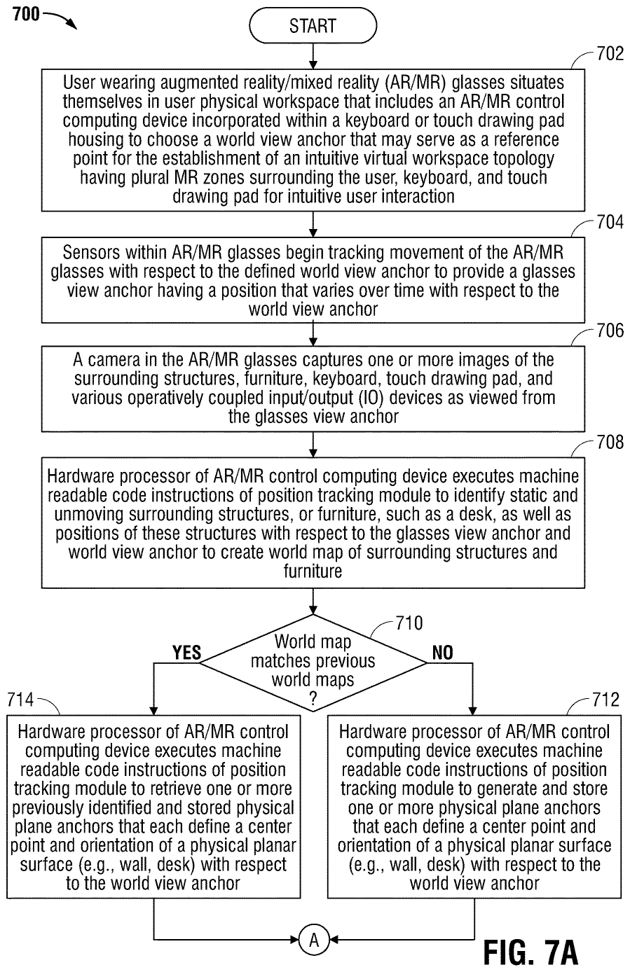

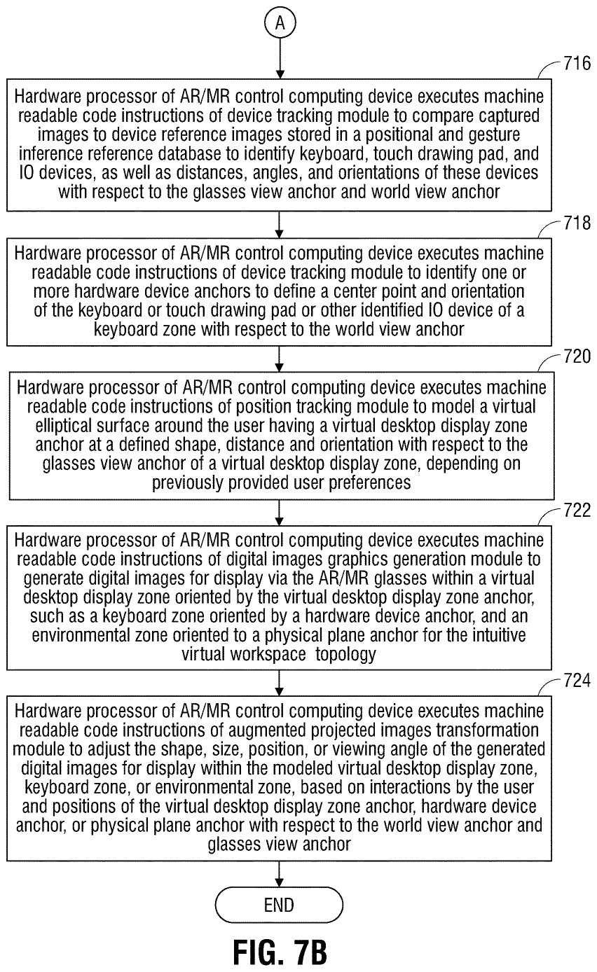

FIG. 7 is a flow diagram illustrating a method of modeling and display of digital images within a virtual desktop display zone, a virtual keyboard zone, and a virtual environmental zone of an intuitive virtual workspace topology for interaction by a user in a mixed reality workspace ecosystem of hardware devices according to an embodiment of the present disclosure. The method of FIG. 7 illustrates a method of modeling and display of digital images within a plurality of display and user interaction zones, including a virtual desktop display zone presented as an elliptical surface surrounding the user's head at eye-level, a keyboard zone surrounding the keyboard or other hardware devices appearing in front of the virtual desktop display zone, and an environmental zone fixed to and coplanar with a nearby static structure outside of the other two zones according to an embodiment of the present disclosure. As described herein, using AR/MR glasses allows users to organize a virtual workspace in the user workspace environment around themselves, projected on top of the real world to create a more immersive workspace making use of the physical space around them. A user may set up a plurality of display and user interaction zones and customize the same, including the virtual desktop display zone presented as a circular, elliptical, or extended elliptical virtual display surface surrounding the user's head at eye-level, a keyboard zone surrounding the keyboard or other hardware devices for the display of projected images representing a taskbar, function row, or virtual widget icons that are anchored to the keyboard, and an environmental zone fixed to and coplanar with a nearby static structure, such as a wall, for the display of lists, de-prioritized software applications windows, ornamental images, various background widgets, such as weather widgets, or others for example.

At block 702, a user wearing augmented reality/mixed reality (AR/MR) glasses in an embodiment may situate themselves in a user physical workspace environment that includes an AR/MR control computing device incorporated within a keyboard or touch drawing pad housing operating as an information handling system according to embodiments herein. The user may choose a world view anchor, based on an initial position of the AR/MR glasses that may serve as a reference point for the establishment of the intuitive virtual workspace topology surrounding the user, keyboard, and touch drawing pad, that includes multiple MR zones for various types of user interaction, including within and between a keyboard zone, a desktop zone, and an environmental zone, for a mixed reality workspace ecosystem with hardware devices of embodiments described herein. For example, in an embodiment described with respect to FIG. 3, a user wearing AR/MR glasses 390 may situate themselves in an MR work environment that includes an AR/MR control computing device incorporated within a keyboard 318 or touch drawing pad 316 housing. The user may choose a world view anchor 381, based on an initial position of the AR/MR glasses 390, that may serve as a reference point for the establishment of an intuitive virtual workspace topology surrounding the user, keyboard 318, and touch drawing pad 316, that includes multiple MR zones for various types of user interaction, including one or more keyboard zones 351, 352, 353, and 354, a desktop zone 320, and one or more environmental zones 384 and 385.

Sensors within the AR/MR glasses in an embodiment at block 704 may begin tracking movement of the AR/MR glasses with respect to the defined world view anchor to provide a glasses view anchor having a position that varies over time with respect to the world view anchor. For example, sensors within the AR/MR glasses 390 in an embodiment may begin tracking movement of the AR/MR glasses 390 with respect to the defined world view anchor 381 to provide a glasses view anchor 382 having a position that varies over time with respect to the world view anchor 381. More specifically, the positional sensor of the operatively coupled AR/MR glasses 390 in an embodiment may comprise an accelerometer providing positional telemetry that may include movement of the AR/MR glasses 390 over time with respect to a world view anchor 381 fixed to an initially recorded position of the AR/MR glasses 390 within the received positional telemetry (e.g., movement from 381 to 382).

At block 706, a camera in the AR/MR glasses in an embodiment may capture one or more images of the surrounding structures, furniture, keyboard, touch drawing pad, user's hands, and various operatively coupled input/output (IO) devices, as viewed from the glasses view anchor. For example, in an embodiment described with respect to FIG. 2, a camera in the AR/MR glasses 290 may capture one or more images of the surrounding structures, furniture, such as desk 295, keyboard 218, touch drawing pad 216, user's hands, and various operatively coupled input/output (IO) devices, such as mouse 299, magnetic pen 298, or an external accelerometer 297 as viewed from the glasses view anchor. In another example embodiment described with respect to FIG. 3, a camera in the AR/MR glasses 390 may capture one or more images of the surrounding structures 373 and 374, furniture such as desk 395, keyboard 318, touch drawing pad 316, and various operatively coupled input/output (IO) devices, such as mouse 399, and magnetic pen 398, as viewed from the glasses view anchor 382. In still other example embodiments described with respect to FIG. 5A, a camera in the AR/MR glasses in an embodiment may capture one or more images of the surrounding structures, furniture, keyboard 518, touch drawing pad 516, user's hands 596, and various operatively coupled input/output (IO) devices 599, as viewed from the glasses view anchor.

A hardware processor of the AR/MR control computing device in an embodiment at block 708 may execute machine readable code instructions of a position tracking module to identify static and unmoving surrounding structures, or furniture, such as a desk, as well as positions of these structures with respect to the glasses view anchor and world view anchor, to create world map of surrounding structures and furniture. For example, in an embodiment described with respect to FIG. 3, a hardware processor of the AR/MR control computing device in an embodiment may execute machine readable code instructions of a position tracking module to identify static and unmoving surrounding structures 373 and 374, or furniture, such as a desk 395, as well as positions of these structures 373, 374, and 395 with respect to the glasses view anchor 382 and world view anchor 381, to create a virtual rendering of a world map of surrounding structures and furniture as a base to generate intuitive virtual workspace topology for interaction by a user in a mixed reality workspace ecosystem of hardware devices according to an embodiment.

At block 710, the hardware processor of the AR/MR control computing device in an embodiment may determine whether the generated world map of surrounding structures and furniture matches a previously stored world map. This may involve comparison of captured images of the world map generated at block 708 above with previously captured digital images of the same physical user workspace (e.g., a desk or room), for example, as stored within the positional gesture and inference reference database and previously associated with a previously stored world map. Such stored world maps may further include previously determined and defined boundaries, orientations, and anchors for various structures, such as walls, or static furniture, such as desks within the user's routinely used workspace, in which the user wishes to currently establish an intuitive virtual workspace topology. If the recently generated world map matches a previously stored world map, this may indicate that the user is attempting to establish the intuitive virtual workspace topology in a room or area in which this process has previously been performed, and the method may proceed to block 714 for retrieval of any previously determined information that may be leveraged to generate the current intuitive virtual workspace topology, thus minimizing expenditure of computing resources. If the recently generated world map does not match a previously stored world map, the user may be attempting to set up an intuitive virtual workspace topology in a new area, and the method may proceed to block 712 for executing machine readable code instructions of image recognition algorithms for identification of static structures, such as walls and desks, as well as their orientations with respect to the world view anchor and glasses view anchor.

In an embodiment at block 712 in which the recently generated world map does not match a previously stored world map, the hardware processor of the AR/MR control computing device may execute machine readable code instructions of the position tracking module along with image recognition algorithms to generate and identify and store one or more physical plane anchors that each define a center point and orientation of a physical planar surface (e.g., wall, desk) with respect to the world view anchor. For example, the hardware processor of the AR/MR control computing device may execute machine readable code instructions of the position tracking module to identify and store one or more physical plane anchors 384 and 385 of a wall structure that each define a center point and orientation of a physical planar surface 374 or 373, respectively with respect to the world view anchor 381. This may also be done with respect to a desk 395 surface as well as an identified hardware device for generating and identifying a hardware device anchor 383. The hardware processor in such an embodiment may execute machine readable code instructions to identify the keyboard 318, the touch drawing pad 316, the static structures 373, and 374, or the desk 395 within the plurality of captured images, modeled as seen from a defined glasses view anchor 382 oriented and fixed to the AR/MR glasses 390 in updated glasses positional telemetry and having a determined position and orientation with respect to a world view anchor 381. The hardware processor executing machine readable code instructions in an embodiment may determine the position and orientation of such physical planar surfaces 374 or 373 or keyboard plane surface in an embodiment by comparing captured images to device reference images stored in a positional and gesture inference reference database to identify the static structure and orientation of the structure planar surfaces 373 and 374 or desk 395 surface with respect to the glasses view anchor 382. The method may then proceed to block 716 for identification of IO devices as seen in the captured images, and positions and orientations thereof with respect to the glasses view anchor.

At block 714, the hardware processor in an embodiment in which the recently generated world map matches a previously stored world map may execute machine readable code instructions of the position tracking module to retrieve one or more previously identified and stored physical plane anchors that each define a center point and orientation of a physical planar surface (e.g., wall, desk) with respect to the world view anchor. For example, the hardware processor may execute machine readable code instructions of the position tracking module to retrieve one or more previously identified and stored physical plane anchors 384 and 385 that each define a center point and orientation of a physical planar surface 374 and 373, respectively, or keyboard planar surface of desk 395 surface with respect to the world view anchor 381. In such an embodiment, the hardware processor executing machine readable code instructions may retrieve the stored and previously modeled world map including the physical plane anchors 383, 384 and 385 fixed and oriented to desk 395 surface or the structural planar surfaces 374 and 373, respectively, modeling a plurality of MR zones 351, 352, 353, 354, 372 and 371, respectively, that are co-planar with the keyboard planar surface of desk 395 or structural planar surfaces 374 and 373, and fixed to the physical plane anchors 383, 384 or 385 based on the determined positions and orientations of the desk 395 surface or static structures 374 and 373 with respect to the world view anchor 381.

A hardware processor of the AR/MR control computing device in an embodiment at block 716 may execute machine readable code instructions of a device tracking module to compare captured images to device reference images stored in a positional and gesture inference reference database to identify the keyboard, the touch drawing pad, and any other operatively coupled IO devices, as well as distances, angles, and orientations of these hardware devices in the physical user workspace with respect to the glasses view anchor and world view anchor. For example, a hardware processor of the AR/MR control computing device in an embodiment may execute machine readable code instructions of a device tracking module to compare captured images to device reference images stored in a positional and gesture inference reference database to identify the keyboard 318, the touch drawing pad 316, and any other operatively coupled IO devices, such as mouse 399, or magnetic pen 398, as well as distances, angles, and orientations of these devices 316, 318, 398 or 399 with respect to the glasses view anchor 382 and world view anchor 381.

At block 718, the hardware processor of the AR/MR control computing device may execute machine readable code instructions of the device tracking module to identify one or more hardware device anchors that each define a center point and orientation of an identified IO device with respect to the world view anchor or glasses view anchor. This may be done in addition to or in connection with detected keyboard planar surface of the desk as described above. For example, the hardware processor of the AR/MR control computing device may execute machine readable code instructions of the device tracking module to identify one or more hardware device anchors 383 for a modeled keyboard zone or zones (e.g., 351, 352, 353, 354 which may be part of a greater keyboard zone around the hardware device anchor 383) that each define a center point and orientation of an identified IO device, such as combined keyboard 318 and touch drawing pad 316 with respect to the world view anchor 381 or glasses view anchor 382. This may be achieved through the hardware processor executing machine readable code instructions to compare the plurality of captured images to device reference images stored in a positional and gesture inference reference database to identify the keyboard 318, touch drawing pad 316 and a keyboard 318 or touch drawing pad 318 orientation of the keyboard planar surface (e.g., planar surface of desk 395) with respect to the glasses view anchor 382.

In an embodiment at block 720, the hardware processor of the AR/MR control computing device may execute machine readable code instructions of the position tracking module to model a virtual elliptical surface surrounding the user having a virtual desktop display zone anchor at a defined distance and orientation with respect to the glasses view anchor, depending on previously provided user preferences for virtual desktop display zone distance and elliptical shape from the user, to generate the virtual desktop display zone of the intuitive virtual workspace topology. For example, the hardware processor of the AR/MR control computing device may execute machine readable code instructions of the position tracking module to model a virtual elliptical surface surrounding the user having a virtual desktop display zone anchor at a defined distance and orientation with respect to the glasses view anchor 381, depending on previously provided user preferences for virtual desktop display zone distance and elliptical shape from the user from a control graphical user interface. The hardware processor executing machine readable code instructions in an embodiment may model a desktop zone 320 within a modeled surface around the user that is at least partially surrounding the user or fully surrounding the user and is fixed to the virtual desktop display zone anchor.

In an embodiment described with respect to FIG. 4A, the hardware processor of the AR/MR control computing device may execute machine readable code instructions of the position tracking module to model a virtual elliptical surface 420 surrounding the user 496 having a virtual desktop display zone anchor 486 at a defined distance and orientation with respect to the glasses view anchor (having the same position and orientation as the virtual desktop display zone anchor 486), depending on previously provided user preferences for virtual desktop display zone distance and elliptical shape from the user. More specifically, the user may have previously selected to lock the position and orientation of the virtual desktop display zone anchor 486 in the same position and orientation of the glasses view anchor, such that the virtual elliptical surface forming the virtual desktop display zone 420 is circular (e.g., an ellipse having an eccentricity of zero) and centered on the virtual desktop display zone anchor 486 or glasses view anchor.

In another example embodiment, the user 496 described with respect to FIG. 4B may have previously selected to lock the position and orientation of the virtual desktop display zone anchor 486 in the same position and orientation of the glasses view anchor, and to form an elliptical surface for the virtual desktop display zone 420, centered on the virtual desktop display zone anchor 486 or glasses view anchor. The hardware processor of the AR/MR control computing device in such an embodiment may execute machine readable code instructions of a digital images graphics generation module to generate digital images for display via the AR/MR glasses 490 within a virtual desktop display zone 420 centered upon and oriented by the virtual desktop display zone anchor 486, but having a more elongated shape than the circular shape described with respect to FIG. 4A, above.

In yet another example embodiment, the user 496 described with respect to FIG. 4C may have previously selected to fix the virtual desktop display zone anchor 486 at a preset distance from the glasses view anchor 496 that provides a comfortable viewing distance for the user 496. The hardware processor of the AR/MR control computing device in such an embodiment may execute machine readable code instructions of a digital images graphics generation module to generate digital images for display via the AR/MR glasses 490 within a virtual desktop display zone 420 centered upon and oriented by the virtual desktop display zone anchor 486 situated at a preset distance from the glasses view anchor 486 that provides a comfortable viewing distance for the user 496.

At block 722, the hardware processor of the AR/MR control computing device may execute machine readable code instructions of a digital images graphics generation module to generate digital images for display via the AR/MR glasses within a virtual desktop display zone centered upon and oriented by the virtual desktop display zone anchor, within a virtual keyboard zone centered upon and oriented by one of the hardware device anchors, and within a virtual environmental zone centered upon and oriented by one or more of the physical plane anchors.

For example, in an embodiment described with respect to FIG. 3, the hardware processor of the AR/MR control computing device may execute machine readable code instructions of a digital images graphics generation module to generate digital images for display via the AR/MR glasses 390 within a virtual desktop display zone 320 centered upon and oriented by the virtual desktop display zone anchor, within one or more virtual keyboard zones 351, 352, 353, or 354 centered upon and oriented by one of the hardware device anchors 383, and within one or more virtual environmental zones 372 or 371 centered upon and oriented by one or more of the physical plane anchors 384 or 385, respectively. In another example embodiment described with respect to FIG. 4A, the hardware processor of the AR/MR control computing device may execute machine readable code instructions of a digital images graphics generation module to generate digital images for display via the AR/MR glasses 490 within a virtual desktop display zone 420 centered upon and oriented by the virtual desktop display zone anchor 486. In still another example embodiment described with respect to FIG. 5A, the hardware processor of the AR/MR control computing device may execute machine readable code instructions of a digital images graphics generation module to generate digital images for display via the AR/MR glasses within a virtual desktop display zone 520 including 522a, 522b, and 522c, and within a virtual keyboard zone 552 centered upon and oriented by one of the hardware device anchors (e.g., device anchor 383 of FIG. 3 fixed to the position of keyboard 318).

A hardware processor of the AR/MR control computing device in an embodiment at block 724 may execute machine readable code instructions of an augmented projected images transformation module to adjust the shape, size, position, or viewing angle of the generated digital images and to instruct the AR/MR glasses to display them within the modeled virtual desktop display zone, virtual keyboard zone, or virtual environmental zone, based on user interactions with and positions of the virtual desktop display zone anchor, one or more hardware device anchors, or one or more physical plane anchors with respect to the world view anchor and glasses view anchor, respectively. For example, in an embodiment described with respect to FIG. 3, the hardware processor of the AR/MR control computing device in an embodiment may then execute machine readable code instructions of an augmented projected images transformation module to adjust the shape, size, position, or viewing angle of the generated digital images and to instruct the AR/MR glasses 390 to display them within the modeled virtual desktop display zone 320, one or more virtual keyboard zones 351, 352, 353, or 354, or one or more virtual environmental zones 372 or 371, based on positions of the virtual desktop display zone anchor, one or device anchors 383, or one or more physical plane anchors 384 or 385, respectively, with respect to the world view anchor 381 and glasses view anchor 382. In another example embodiment described with respect to FIG. 5A, the hardware processor of the AR/MR control computing device in an embodiment may also execute machine readable code instructions of an augmented projected images transformation module to adjust the shape, size, position, or viewing angle of the generated digital images and to instruct the AR/MR glasses to display them within the modeled virtual desktop display zone including 522a, 522b, and 522c, and virtual keyboard zone 552, based on positions of the virtual desktop display zone anchor, and one or device anchors, respectively. The method for modeling and display of digital images within a virtual desktop display zone, a virtual keyboard zone, and a virtual environmental zone may then end.

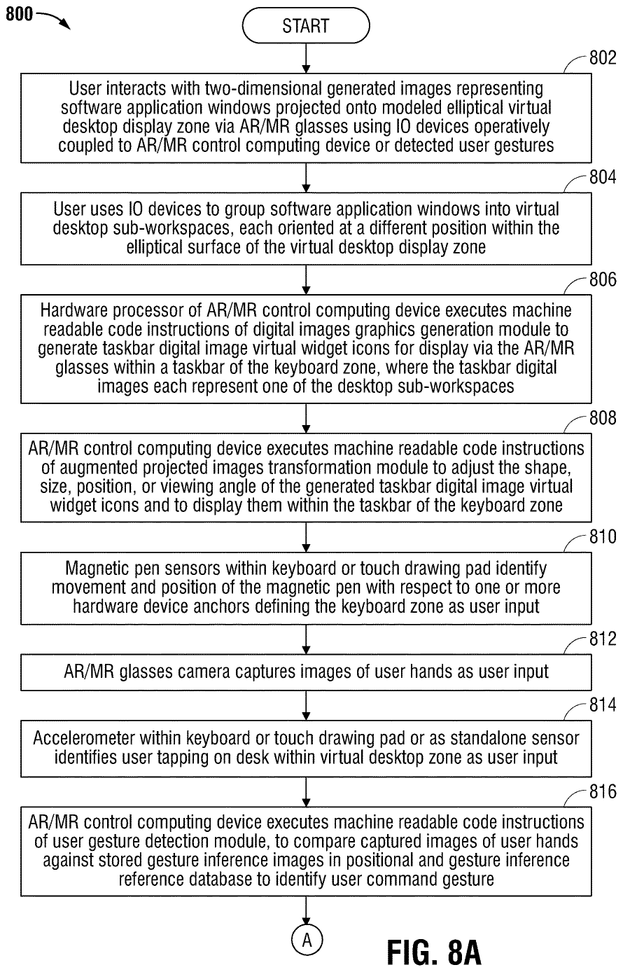

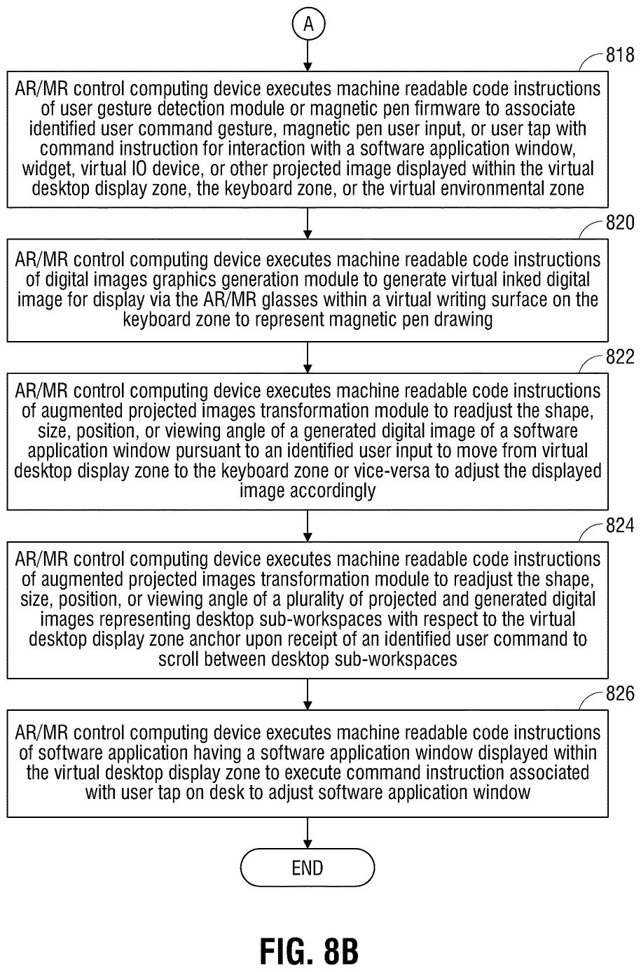

FIG. 8 is a flow diagram illustrating a method of processing user input in a mixed reality workspace ecosystem of hardware devices indicating interaction with digital images displayed within the environmental zone, the keyboard zone, or the virtual desktop display zone of an intuitive virtual workspace topology with hardware devices or gestures according to an embodiment of the present disclosure. The method of processing user input interacting with digital images displayed within the environmental zone, the keyboard zone, or the virtual desktop display zone, and received via one or more operatively coupled input/output (IO) devices, recognized user gesture, or tapping on a desk supporting the keyboard or touch drawing pad provides for seamless interaction with the intuitive virtual workspace topology in the mixed reality workspace ecosystem of hardware devices of embodiments herein. In an embodiment, the user may interact with digital images displayed within the environmental zone, the keyboard zone, or the virtual desktop display zone, via one or more operatively coupled input/output (IO) devices, such as a mouse or magnetic pen, for example, or through recognized user gesture or tapping on the desk supporting the keyboard or touch drawing pad.

At block 802, a user in an embodiment may interact with generated images representing software application windows projected onto a modeled elliptical virtual desktop display zone via AR/MR glasses using IO devices operatively coupled to an AR/MR control computing device or captured images of gestures in the user workspace. For example, in embodiments described with respect to FIGS. 5A, 5B, 5C, and 5D, a user may interact with these generated images representing software application windows projected onto a modeled elliptical virtual desktop display zone 520 that includes 522a, 522b, and 522c, via AR/MR glasses, using IO devices 599 operatively coupled to the AR/MR control computing device. A camera in the AR/MR glasses may capture one or more images of the user's hands 596 as the user performs a swiping motion to shift positions of the various desktop sub-workspaces 522a, 522b, and 522c, 522d, and 522e, as viewed from the glasses view anchor or presents other user gestures as user input. The camera may also capture one or more images of the user's hands 596, and various operatively coupled input/output (IO) devices, such as magnetic pen 598, as they interact with generated images, such as 521, representing software application windows projected onto a modeled elliptical virtual desktop display zone 520.

A user in an embodiment at block 804 may use one or more operatively coupled IO devices to group software application windows into software application window sub-workspaces, each oriented at a different position around the elliptical virtual desktop display zone. For example, the user may use one or more operatively coupled IO devices 599 to group software application windows into software application window sub-workspaces, such as 522a, 522b, or 522c, each oriented at a different position within the elliptical virtual desktop display zone. For example, virtual desktop sub-workspace 522a may be selected by the user for display within a front-facing portion of the elliptical virtual desktop display zone, which may be situated directly in front of the user and the AR/MR glasses.

At block 806, a hardware processor of the AR/MR control computing device in an embodiment may execute machine readable code instructions of a digital images graphics generation module to generate taskbar digital image virtual widget icons for display via the AR/MR glasses within a taskbar of the keyboard zone, where the taskbar digital image virtual widget icons each represent one of the desktop sub-workspaces. For example, the hardware processor of the AR/MR control computing device in an embodiment may also execute machine readable code instructions of the digital images graphics generation module to generate one or more sets of taskbar digital image virtual widget icons 552a, 552b, or 552c for display via the AR/MR glasses within a taskbar of the virtual keyboard zone 552, where the taskbar digital images 552a, 552b, or 552c each represent one of the desktop sub-workspaces 522a, 522b, or 522c, respectively.

A hardware processor of the AR/MR control computing device in an embodiment at block 808 may execute machine readable code instructions of an augmented projected images transformation module to adjust the shape, size, position, or viewing angle of the generated taskbar digital image virtual widget icons and to display them within the taskbar of the virtual keyboard zone. For example, the hardware processor of the AR/MR control computing device may execute machine readable code instructions of the augmented projected images transformation module to adjust the shape, size, position, or viewing angle of the generated taskbar digital image virtual widget icons 552a, 552b, or 552c, and to display them within the taskbar of the virtual keyboard zone 552.

In an embodiment at block 810, magnetic pen sensors within the keyboard or touch drawing pad may identify movement and position of the magnetic pen with respect to one or more hardware device anchors defining the virtual keyboard zone. For example, in an embodiment described with respect to FIG. 3, magnetic pen sensors within the keyboard 318 or the touch drawing pad 316 may identify movement and position of the magnetic pen 398 with respect to one or more hardware device anchors 383 defining the one or more virtual keyboard zones 351, 352, 353, or 354. In other example embodiments described with respect to FIGS. 6A, 6B, and 6C, magnetic pen sensors 698b or 698c within the keyboard 618 or the touch drawing pad 616, respectively, may identify movement and position of the magnetic pen 698 with respect to one or more hardware device anchors fixed to the keyboard 618, touch drawing pad 616, or both, defining the virtual keyboard zone.

At block 812, the AR/MR glasses camera in an embodiment may capture images of the user hands as they interact with physical IO devices or images projected within one or more of the environmental zone, keyboard zone, or desktop zone, via the AR/MR glasses. In one example embodiment described with respect to FIGS. 5A, 5B, 5C, and 5D a camera in the AR/MR glasses may capture one or more images of the user's hand 596 as the user performs a swiping motion to shift positions of the various desktop sub-workspaces 522a, 522b, 522c, 522d, and 522e, as viewed from the glasses view anchor. The camera may capture images of the user hands 596 as they interact with physical IO devices 599 or images projected within one or more of the environmental zone, keyboard zone 552, or desktop zone that includes 522a, 522b, and 522c, via the AR/MR glasses, or images of various operatively coupled input/output (IO) devices, such as magnetic pen 598, as viewed from the glasses view anchor. The captured images of the user hands 596 may be processed by a hardware processor at the AR/MR control computing device executing machine readable code instructions of a user gesture detection module for comparison with images for particular user input gestures and then interpreted as user input in embodiments herein.

An accelerometer within the keyboard or touch drawing pad or as standalone sensor in an embodiment at block 814 may identify a user tapping on the desk within a virtual desktop display zone as user input. For example, in an embodiment described with respect to FIG. 3, an accelerometer within the keyboard 318 or touch drawing pad 316 or as standalone sensor 397 in an embodiment may identify a user tapping on the desk 395 within a virtual desktop display zone 354.

At block 816, a hardware processor of the AR/MR control computing device may execute machine readable code instructions of the user gesture detection module, to compare captured images of user hands against stored gesture inference images in the positional and gesture inference reference database to identify a user command gesture as a user input. For example, in an embodiment described with respect to FIGS. 5A, 5B, and 5C the hardware processor of the AR/MR control computing device may recognize a gesture with the user's hand 596 such as that described above with respect to block 812 by executing machine readable code instructions of a user gesture detection module, to compare captured images of the user hands 596 against stored gesture inference images in the positional and gesture inference reference database to identify user input from the user command gesture. More specifically, a hardware processor of the AR/MR control computing device may execute machine readable code instructions of a user gesture detection module, to compare captured images of user hands 596 against stored gesture inference images in the positional and gesture inference reference database to identify a user input from a user command gesture, such as dragging and dropping the two-dimensional generated image 521 from the virtual desktop display zone 520 to a keyboard zone 554. In another example embodiment described with respect to FIG. 6D, a hardware processor of the AR/MR control computing device in an embodiment may execute machine readable code instructions of a user gesture detection module, to compare captured images of user hands 696 against stored gesture inference images in the positional and gesture inference reference database to identify a user input from a user command gesture, such as the user pressing a button virtual widget icon 653a within a projected image of a software application window for a virtual I/O device widget 653, such as for a calculator application.

In an embodiment at block 818, the hardware processor of the AR/MR control computing device may execute machine readable code instructions of the user gesture detection module, or magnetic pen firmware to associate an identified user input with a user command gesture, magnetic pen usage, or user tap with a command instruction for interaction with a software application window, widget, virtual IO device, ornamental image, or other projected image displayed within the virtual desktop display zone, the virtual keyboard zone, or the virtual environmental zone of the intuitive virtual workspace topology of the mixed reality workspace ecosystem of embodiments herein. For example, in embodiments described with reference to FIGS. 5A, 5B, 5C, and 5D, the hardware processor of the AR/MR control computing device may execute machine readable code instructions of the user gesture detection module, or magnetic pen firmware to associate an identified user command gesture, magnetic pen usage, or user tap with a command instruction for interaction with a software application window, widget, virtual IO device, or ornamental image represented by a projected image displayed within the virtual desktop display zone that includes 522a, 522b, and 522c, the virtual keyboard zone 552, or the virtual environmental zone. More specifically, the hardware processor of the AR/MR control computing device may execute machine readable code instructions of the user gesture detection module to associate an identified user command gesture tapping one of the taskbar digital images 552a with a command to place the desktop sub-workspace 522a associated with the taskbar digital image 552a for display within a front-facing portion of the elliptical virtual desktop display zone, which may be situated directly in front of the user and the AR/MR glasses. In another example, the hardware processor of the AR/MR control computing device may execute machine readable code instructions of the user gesture detection module to associate the identified user command gesture such as a swipe to shift positions of the various desktop sub-workspaces 522a, 522b, 522c, 522d, and 522e, with a command instruction for such a movement of the displayed images of the various desktop sub-workspaces 522a, 522b, 522c, 522d, and 522e.

In yet another example, the hardware processor of the AR/MR control computing device may execute machine readable code instructions of the user gesture detection module, or magnetic pen firmware to associate an identified user command gesture, or magnetic pen 598 usage with a command instruction for interaction with a software application window represented by a projected image 521 displayed within the virtual desktop display zone 520, such as dragging and dropping the generated image 521 of a software application window, for example, from the virtual desktop display zone 520 to a keyboard zone 554. In such an embodiment, the hardware processor may execute machine readable code instructions to readjust an application window image 521 shape, size, position or viewing angle for the software application window, based on position and orientation of the hardware device anchor with respect to the glasses view anchor, for display within the keyboard zone 552. For example, with respect to FIG. 3, the moved software application window from the virtual desktop display zone 320 maybe readjusted to a keyboard subzone 351, 352, 353, or 354 in various embodiments.

In still other example embodiments described with respect to FIGS. 6A, 6B, 6C, and 6D, the hardware processor executing machine readable code instructions may identify a user command to one of the plurality of software application windows displayed within the keyboard zone 650, based at least partially on such a received notification of a user 696 tap on a desk 695 from an accelerometer of the keyboard 618 or touch drawing pad 616. The hardware processor of the AR/MR control computing device may execute machine readable code instructions of the user gesture detection module to associate such an identified user command gesture, along with a user tap identified by an accelerometer in some embodiments, as described above with respect to FIG. 6C, for example, with a command instruction for interaction with the calculator application represented by the software application window for the virtual I/O device widget 653.

At block 820, the hardware processor of the AR/MR control computing device may execute machine readable code instructions of the digital images graphics generation module to generate and a virtual inked digital image for display via the AR/MR glasses within a virtual writing surface such as a virtual window, document, or note on the virtual desktop display zone, to represent magnetic pen drawing. For example, in an embodiment described with reference to FIG. 6B, the hardware processor of the AR/MR control computing device may execute machine readable code instructions of the digital images graphics generation module to generate a virtual inked digital image, such as the written word “Pick,” for display via the AR/MR glasses within a virtual window, document, or note of virtual writing surface 654a on the virtual desktop display zone 654, to represent magnetic pen drawing. The hardware processor may then execute machine readable code instructions to adjust the shape, size, position or viewing angle of the generated magnetic pen ink image, such as the written word “Pick,” having a pattern following the received movement of the magnetic pen 654a, based on the position and orientation of the hardware device anchor fixed to the keyboard 618, the touch drawing pad 616, or both, with respect to the glasses view anchor, for display via the AR/MR glasses within the keyboard zone 654.

The hardware processor of the AR/MR control computing device in an embodiment at block 822 may execute machine readable code instructions of the augmented projected images transformation module to readjust the shape, size, position, or viewing angle of a generated digital image representing a software application window that an identified user command has dragged from the virtual desktop display zone to the virtual keyboard zone, and to display the image within the virtual keyboard zone. For example, the hardware processor of the AR/MR control computing device may execute machine readable code instructions of the user gesture detection module, or magnetic pen firmware to associate an identified user command gesture, or magnetic pen 598 usage with a command instruction for interaction with a software application window represented by a projected image 521, such as dragging and dropping the generated image of a software application window 521 from the virtual desktop display zone 520 to a keyboard zone 554 or vice-versa, or to an environmental zone in some embodiments. In such an embodiment, the hardware processor may execute machine readable code instructions to readjust a software application window image 521 shape, size, position or viewing angle for the software application window, based on position and orientation of the hardware device anchor with respect to the glasses view anchor, for display within the keyboard zone 554. Similar adjustments may be made when a software application window 521 is transitioned by the user to either the virtual desktop display zone or the environmental zone from another MR zone during navigation within the intuitive virtual workspace topology in various embodiments herein.

At block 824, the hardware processor of the AR/MR control computing device may execute machine readable code instructions of the augmented projected images transformation module to readjust the shape, size, position, or viewing angle of a plurality of projected and generated digital images representing desktop sub-workspaces with respect to the virtual desktop display zone anchor upon receipt of an identified user command to scroll between desktop sub-workspaces. For example, in an embodiment described with respect to FIG. 5D, the hardware processor of the AR/MR control computing device may execute machine readable code instructions of the augmented projected images transformation module to readjust the shape, size, position, or viewing angle of a plurality of projected and generated digital images representing desktop sub-workspaces 522a, 522b, 522c, 522d, and 522e with respect to the virtual desktop display zone anchor upon receipt of the identified user command to scroll between desktop sub-workspaces 522a, 522b, 522c, 522d, and 522e.

A hardware processor of the AR/MR control computing device, in an embodiment at block 826, may execute machine readable code instructions of software application having a software application window displayed within the virtual desktop display zone to execute a command instruction associated with a user tap on the desk. For example, in an embodiment described with respect to FIG. 6D, the hardware processor of the AR/MR control computing device may execute machine readable code instructions of a software application having a software application window displayed within the virtual desktop display zone 650 to execute the identified user command instruction associated with the user 696 tap on the desk 695. The hardware processor executing machine readable code instructions may then generate and adjust an updated image shape, size, position or viewing angle of an updated generated digital image of the software application window reflecting processing of the identified user command instruction by the software application, based on the position and orientation of the hardware device anchor 683 with respect to the glasses view anchor 682, for display via the AR/MR glasses within the keyboard zone 650. The method for processing user input indicating interaction with digital images displayed within the environmental zone, the keyboard zone, or the virtual desktop display zone may then end.

The blocks of the flow diagram of FIGS. 7 and 8 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those capable in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

1. An augmented reality/mixed reality (AR/MR) control computing device operating a mixed reality workspace ecosystem of hardware devices in a physical user workspace to navigate an intuitive-virtual workspace topology comprising:
a data port for receiving glasses positional telemetry and a plurality of captured images of a static structure and a keyboard from operatively coupled AR/MR glasses;
a hardware processor executing machine readable code instructions to identify the keyboard and the static structure within the plurality of captured images and modeled from a defined glasses view anchor oriented and fixed to the AR/MR glasses in the glasses positional telemetry for the mixed reality workspace ecosystem of hardware devices;
the hardware processor executing machine readable code instructions to identify a hardware device anchor fixed and oriented to an identified keyboard planar surface, a virtual desktop display zone anchor fixed at a defined distance with respect to the glasses view anchor, and a physical plane anchor fixed and oriented to a structural planar surface of an identified static structure;
the hardware processor executing machine readable code instructions to model a keyboard zone co-planar with the keyboard planar surface and fixed to the hardware device anchor, a desktop zone with a modeled elliptical surface displayed around the user that is fixed to the virtual desktop display zone anchor, and an environmental zone that is co-planar with the structural planar surface and fixed to the physical plane anchor for an intuitive-virtual workspace topology; and
the hardware processor executing machine readable code instructions to generate and adjust shape, size, position or viewing angle a plurality of generated digital images based on position and orientation of the physical plane anchor, hardware device anchor, and virtual desktop display zone anchor with respect to the glasses view anchor, for display via the AR/MR glasses within the environmental zone, the keyboard zone, and the virtual desktop display zone for intuitive navigation in the virtual workspace topology by a user in the physical user workspace.

2. The AR/MR control computing device of claim 1, wherein the virtual desktop display zone anchor is set at a user-defined distance or user-defined orientation with respect to the glasses view anchor for movement of the AR/MR glasses with respect to the modelled elliptical surface.

3. The AR/MR control computing device of claim 1, wherein the modeled elliptical surface displayed in the virtual desktop display zone has a user-defined, elliptical shape around the user selected from a cylindrical surface shape, an elongated elliptical surface shape, or stadium shape with a user-defined distance to a front-facing portion of the elliptical shape.

4. The AR/MR control computing device of claim 1, wherein the positional sensor of the operatively coupled AR/MR glasses is an accelerometer and the positional telemetry includes movement of the AR/MR glasses over time with respect to a world view anchor for the generated virtual workspace topology of the mixed reality workspace ecosystem of hardware devices fixed to an initially recorded position of the AR/MR glasses within the received positional telemetry of the user physical workspace.

5. The AR/MR control computing device of claim 1 further comprising:
the hardware processor executing machine readable code instructions to compare the plurality of captured images to device reference images stored in a positional and gesture inference reference database to identify the keyboard from comparison to stored keyboard images and a keyboard orientation of the hardware device anchor for the keyboard planar surface with respect to the glasses view anchor, wherein the keyboard houses the AR/MR control computing device.

6. The AR/MR control computing device of claim 1 further comprising:
the hardware processor executing machine readable code instructions to compare captured images to device reference images stored in a positional and gesture inference reference database to identify the static structure and orientation of the physical plane anchor for the structure planar surface with respect to the glasses view anchor.

7. The AR/MR control computing device of claim 1 further comprising:
the hardware processor executing machine readable code instructions to generate and adjust an image shape, size, position or viewing angle of virtual widget icons, virtual I/O device images, and virtual writing surface with magnetic pen ink image based on position and orientation of the hardware device anchor with respect to the glasses view anchor for display by the AR/MR glasses fixed relative to the keyboard within the keyboard zone.

8. A method of executing machine readable code instructions for generating an intuitive virtual workspace topology including multiple mixed reality software application display zones for various types of user interaction with an AR/MR control computing device comprising:
receiving, via a data port, glasses positional telemetry and a plurality of captured images of a static structure, a keyboard housing the AR/MR control computing device, and an operatively coupled drawing touch pad, and an operatively coupled IO device in a user physical workspace from operatively coupled AR/MR glasses;
identifying the keyboard, the drawing touch pad, the IO device, and the static structure within the plurality of captured images to generate a modeled virtual workspace topology in a mixed reality workspace ecosystem as seen from a defined glasses view anchor oriented and fixed to the AR/MR glasses in the glasses positional telemetry, via a hardware processor executing the machine readable code instructions;
identifying, via a hardware processor executing machine readable code instructions, a keyboard hardware device anchor fixed and oriented to an identified keyboard planar surface, a virtual desktop display zone anchor fixed at a defined virtual desktop display zone distance from the defined glasses view anchor, and a physical plane anchor fixed and oriented to a structural planar surface of an identified static structure;
modeling, via the hardware processor executing machine readable code instructions, a keyboard zone that is co-planar with the keyboard planar surface and fixed to the hardware device anchor, a desktop zone with a modeled elliptical surface around the user that is fixed to the virtual desktop display zone anchor, and an environmental zone that is co-planar with the structural planar surface and fixed to the physical plane anchor of the virtual workspace topology; and
generating and adjusting an image shape, size, position or viewing angle of each of a plurality of generated digital images displayed via the AR/MR glasses of a plurality of software application windows for user interaction with executing a software application executing-via the hardware processor based on position and orientation of the physical plane anchor, hardware device anchor, and virtual desktop display zone anchor with respect to the glasses view anchor within the environmental zone, the keyboard zone, and the virtual desktop display zone, respectively.

9. The method of claim 8 further comprising:
displaying, via the hardware processor executing machine readable code instructions and AR/MR glasses, a plurality of thumbnail image virtual widget icons representing a subset of the one or more software application windows within a virtual taskbar displayed in the keyboard zone for accessing software application window sub-workspaces of software application windows displayed in the modeled elliptical surface of the virtual desktop display zone.

10. The method of claim 8 further comprising:
grouping the plurality of software application windows into a plurality of software application window sub-workspaces; and
displaying, via the AR/MR glasses, a first of the plurality of software application window sub-workspaces at a user-specified, front-facing location of the modeled elliptical surface within the virtual desktop display zone via the hardware processor executing machine readable code instructions.

11. The method of claim 8 further comprising:
receiving user input via the IO device for the software application; and
generating and adjusting an updated image shape, size, position or viewing angle of each of an updated generated digital image of the software application window, based on the received user input and position and orientation of the physical plane anchor, device anchor, or virtual desktop display zone anchor with respect to the glasses view anchor, for display via the AR/MR glasses within the environmental zone, the keyboard zone, or the virtual desktop display zone of the intuitive virtual workspace topology, via the hardware processor executing machine readable code instructions.

12. The method of claim 8 further comprising:
receiving magnetic pen positional telemetry identifying movement of an operatively coupled magnetic pen with respect to the hardware device anchor from magnetic pen sensors in the keyboard; and
generating and adjusting a magnetic pen ink image shape, size, position or viewing angle of virtual ink on a virtual writings surface having a pattern following the received movement of the magnetic pen, based on the position and orientation of the hardware device anchor with respect to the glasses view anchor for display via the AR/MR glasses within the keyboard zone.

13. The method of claim 8 further comprising:
receiving a user instruction to move one of the plurality of software application windows displayed within the virtual desktop display zone to the keyboard zone via the IO device or the magnetic pen; and
readjusting a software application window image shape, size, position or viewing angle, via the hardware processor executing machine readable code instructions, for the one of the plurality of software application windows based on position and orientation of the hardware device anchor, with respect to the glasses view anchor, for display within the keyboard zone.

14. The method of claim 8 further comprising:
identifying a user gesture command, via the hardware processor executing machine readable code instructions, to scroll between a plurality of subsets of the plurality of software application windows grouped together into software application window sub-workspaces and displayed on the modeled elliptical surface based on identification of pose, position, or movement of a user's hand within the plurality of captured images from the AR/MR glasses and displaying one of the plurality of software application window sub-workspaces at a user-specified, front-facing location within the virtual desktop display zone based on the user gesture command.

15. An augmented reality/mixed reality (AR/MR) control computing device operating a mixed reality workspace ecosystem of hardware devices in a physical user workspace to navigate an intuitive virtual workspace topology comprising:
a data port for receiving glasses positional telemetry and a plurality of captured images of a keyboard from operatively coupled AR/MR glasses in the physical user workspace;
the a hardware processor executing machine readable code instructions to identify a hardware device anchor fixed and oriented to an identified keyboard planar surface within the plurality of captured images and modeling the hardware device anchor for a keyboard zone from a defined glasses view anchor oriented and fixed to the AR/MR glasses in the glasses positional telemetry for the mixed reality workspace ecosystem;
the hardware processor executing machine readable code instructions to identify a virtual desktop display zone anchor fixed at a defined desktop distance from the AR/MR glasses with respect to the glasses view anchor for a distance of a modeled elliptical surface in a virtual desktop display zone;
the hardware processor executing machine readable code instructions to model the keyboard zone that is co-planar with the keyboard planar surface and fixed to the hardware device anchor, and a desktop zone with the modeled elliptical surface displayed around the user that is fixed to the virtual desktop display zone anchor for an virtual workspace topology; and
the hardware processor executing machine readable code instructions to generate a plurality of generated digital images based on position and orientation of the hardware device anchor, and the virtual desktop display zone anchor with respect to the glasses view anchor for display via the AR/MR glasses within the keyboard zone and the virtual desktop display zone for intuitive-navigation in the intuitive virtual workspace topology by a user in the physical user workspace;
the data port receiving user input to move one-a first software application window of the a plurality of software application windows displayed within the virtual desktop display zone to the keyboard zone or vice-versa via an IO device or a detected hand gesture from the captured images of the physical user workspace; and
the hardware processor executing machine readable code instructions generating and adjusting an updated image shape, size, position or viewing angle of each of an updated generated digital image of the first software application window based on the received user input and position and orientation of the hardware device anchor or virtual desktop display zone anchor with respect to the glasses view anchor when the glasses view anchor is transitioned from the keyboard zone to the virtual desktop display zone or from the virtual desktop display zone to the keyboard zone.

16. The information handling system of claim 15 further comprising:
the hardware processor executing machine readable code instructions to identify a user gesture command as the user input to move one of the plurality of software application windows displayed within the virtual desktop display zone to the keyboard zone, based on identification of pose, position, or movement of a user's hand within the plurality of captured images; and
the hardware processor executing machine readable code instructions to readjust the software application window image shape, size, position or viewing angle for the one of the plurality of software application windows, based on position and orientation of the hardware device anchor with respect to the glasses view anchor, for display on the keyboard planar surface within the keyboard zone from the modeled elliptical surface of the virtual desktop display zone.

17. The information handling system of claim 15 further comprising:
the hardware processor executing machine readable code instructions to identify a user gesture command for user input to one of the plurality of software application windows displayed within the keyboard zone, based on identification of pose, position, or movement of a user's hand within the plurality of captured images and a received notification of a user tap from an accelerometer of the keyboard; and
the hardware processor executing machine readable code instructions to generate and adjust an updated image shape, size, position or viewing angle of each of an updated generated digital image of the software application window, based on the received user input and position and orientation of the hardware device anchor with respect to the glasses view anchor, for display via the AR/MR glasses within the keyboard zone.

18. The AR/MR control computing device of claim 15, wherein the virtual desktop display zone anchor is set at a user-defined distance or user-defined orientation with respect to the glasses view anchor for a viewing distance.

19. The AR/MR control computing device of claim 15, wherein the modeled elliptical surface of the virtual desktop display zone is selected by the user from a cylindrical shape, an elongated elliptical shape, and a stadium shape with user input received from the user at a control graphical user interface.

20. The AR/MR control computing device of claim 15 further comprising:
the hardware processor executing machine readable code instructions receive user input that is a user gesture command from the captured images of a user's hand in the physical user workspace to compare the plurality of captured images to gesture reference images stored in a positional and gesture inference reference database to identify a user gesture command, based on identification of pose, position, or movement of the user's hand.
